(19) United States
(12) Patent Application Publication
(10) Pub. No.: US 2004/0163047 A1
(43) Pub. Date: Aug. 19, 2004

(54) Layout system, layout program, and layout method

(75) Inventors: Atsushi Nagahara, Chino-shi (JP); Hirotaka Ohashi, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/736,745

(22) Filed: Dec. 17, 2003

(30) Foreign Application Priority Data
Dec. 25, 2002 (JP) 2002-375566
Dec. 25, 2002 (JP) 2002-375582
Nov. 7, 2003 (JP) 2003-378353

(51) Int. Cl. G06F 17/00

(52) U.S. Cl. 715/517

(57) ABSTRACT

A layout system is provided which suitably reflects a designer s intention on a layout and achieves high flexibility for a layout.

In a page template, a movable direction and a movable region can be set for one information storage frame. A contents distribution terminal 100 stores articles in a plurality of information storage frames according to the page template of a template registration DB 42. When the plurality of information storage frames overlap each other as a result of storing the articles, the overlapping information storage frames are moved along the movable direction based on the setting on the movable direction in the page template so that the information storage frames do not overlap each other Further, when the plurality of information storage frames overlap each other as a result of storing the articles, the overlapping information storage frames are moved in the movable region based on the setting on the movable region in the page template so that the information storage frames do not overlap each other.

### BACKGROUND OF THE INVENTION

1. Field of the Invention

The present invention relates to a system, a program, and a method for laying out listed information such as a document and an image and particularly relates to a layout system, a layout program, and a layout method whereby a designer's intention is preferably reflected on a layout and high flexibility is achieved for the layout.

2. Description of the Related Art

Digital contents distribution systems are conventionally available for providing the user with digital contents including news. Generally in such digital contents distribution systems, some digital contents are read from a contents registration database (hereinafter, the database will be simply referred to as DB), the read digital contents are edited, and the edited digital contents are distributed to the user. In a process for editing digital contents, digital contents are laid out to provide higher visibility for the user. Such a laying-out technique includes a document processor disclosed in Patent Document 1 (hereinafter referred to as a first conventional example) and a system for creation of digital contents disclosed in Patent Document 2 (hereinafter referred to as a second conventional example).

The first conventional example comprises an information storage frame producing section for producing an information storage frame, an information storage frame size storing section for storing the size and position of an information storage frame, a first reference line setting section for setting a reference line on a sheet, a first reference line position storing section for storing the position of the reference line set by the first reference line setting section, a second reference line setting section for setting a reference line in the information storage frame, a second reference line position storing section for storing the position of the reference line set by the second reference line setting section, a rearranging section for rearranging the information storage frame, and a rearrangement instructing section for instructing rearrangement, wherein a layout is designed so that the reference line set on the sheet and the reference line in the information storage frame are coincident with each other. Since the reference line can be set in the information storage frame, when one of a plurality of information storage frames is changed on the sheet or the reference line is changed on the sheet, desired alignment can be readily performed and the laying-out time can be reduced significantly.

In the second conventional example, a layout definition file defines a state in which a first information storage frame and a second information storage frame overlap partially each other and are arranged in a layout region. Then, listed information is stored in a plurality of information storage frames with reference to the layout definition file, so that digital contents are generated. When listed information is stored in the information storage frames, the shape and position of the first information storage frame are determined according to an amount of the listed information to be stored in the first information storage frame. Based on the determined shape and position, the shape and position of the second information storage frame are determined so as not to overlap the first information storage frame.

Thus, it is possible to reduce a probability of impairment, which is caused by the contents of listed information, an amount of information, and a logical structure, on a layout intended by the designer, and to relatively increase flexibility of the order of listed information.

(Patent Document 1)

Japanese Patent Laid-Open No. 6-149794

(Patent Document 2)

Japanese Patent Laid-Open No. 2002-297572

### SUMMARY OF THE INVENTION

In a process of editing digital contents, when a layout is mechanically generated, visibility and appearance may be seriously impaired. For example, the following measure is taken: a designer designs some layout models beforehand and digital contents are edited based on the layout models so as to generate a layout in compliance with the designer's intention. In this case, it is desirable to edit digital contents so as to generate a layout substantially in compliance with the designer's intention regardless of the contents of information to be listed, an amount of information, and a logical structure.

However, in the first conventional example, the rearranging section rearranges the information storage frame. Since it is necessary to set a reference line in the information storage frame, a layout is limited to a certain degree, resulting in less flexibility for a layout.

Further, in the second conventional example, the shape and position of the first information storage frame are determined according to an amount of listed information to be stored in the first information storage frame, and the shape and position of the second information storage frame are determined based on the determined shape and position so as not to overlap the first information storage frame. Thus, it is possible to reduce a probability of impairment on a layout intended by the designer. However, the position of the second information storage frame is automatically determined during layout processing and thus it is difficult to sufficiently reflect the designer's intention on the layout.

Namely, in view of more reflection of a designer's intention, it is desirable to allow the designer to determine beforehand how the second information storage frame is changed when the first information storage frame and the second information storage frame overlap each other.

The present invention is devised in consideration of the above unsolved problem of the conventional art and has as an object the provision of a layout system, a layout program, and a layout method whereby a designer's intention is preferably reflected on a layout and high flexibility is achieved for the layout.

(Invention 1)

In order to attain the above objective, a layout system of Invention 1 comprises layout section for laying out listed information. The layout section generates a layout by storing the listed information in a plurality of information storage frames arranged in a predetermined layout region. The movable direction of the information storage frames on the layout region is set, and the layout section is set to move one of the information storage frames along the movable direction relative to the other information storage frames.

With this configuration, listed information is stored in the information storage frame by the layout section, so that a layout is generated. In a layout process, the information storage frame is moved along the movable direction relative to the other information storage frames.

Therefore, by permitting the designer to set a movable direction beforehand for the necessary information storage frames, the information storage frames are moved along a direction intended by the designer.

Hence, the designer s intention is more readily reflected on a layout. Further, since it is not necessary to set a reference line in the information storage frame, flexibility can be relatively improved for a layout.

In this case, the movable direction may be set anywhere. For example, the movable direction may be set in the information storage frame, listed information, or a layout template. Alternatively, the movable direction may be set as a program or an argument (the same applies hereinafter). Further, the listed information includes character information, image information, and other kinds of information (the same applies hereinafter). Moreover, the layout indicates a display layout when listed information is laid out for providing a display on a screen, and indicates a printing layout when listed information is laid out to print the information on a sheet (the same applies hereinafter).

Further, the system may be formed as a single device, a terminal, and other devices or may be formed as a network system for connecting a plurality of devices, terminals, and other devices so as to carry out communications. In the latter case, the components can belong to any one of the plurality of devices as long as they are connected so as to carry out communications (the same applies hereinafter).

(Invention 2)

In the layout system of Invention 1, a layout system of Invention 2 is characterized in that when the plurality of information storage frames overlap each other with the listed information stored in the information storage frames, the layout section moves at least one of the plurality of overlapping information storage frames along the movable direction of the information storage frames with the plurality of overlapping information storage frames not overlapping each other.

With this configuration, the layout section stores the listed information in the plurality of information storage frames, so that a layout is generated. When the plurality of information storage frames overlap each other as a result of storing the listed information, since the movable direction is set for the information storage frames, the layout section moves the overlapping information storage frames along the movable direction so that the information storage frames do not overlap each other.

Therefore, by permitting the designer to set a movable direction beforehand for the necessary information storage frames, in the case where the plurality of information storage frames overlap each other, the information storage frame is moved along the direction intended by the designer and listed information is stored in the information storage frames so that the information storage frames do not overlap each other.

Hence, the designer's intention is more readily reflected on a layout and a relatively proper layout can be obtained regardless of the contents of listed information, an amount of information, and a logical structure.

The case where the plurality of information storage frames overlap each other includes not only the case where listed information is stored in all of the plurality of information storage frames, but also the case where listed information is stored in some of the plurality of information storage frames. In the latter case, the information storage frame having stored listed information and the information storage frame having not stored listed information overlap each other (the same applies hereinafter).

(Invention 3)

A layout system of Invention 3 comprises layout section for laying out listed information. The layout section generates a layout by storing the listed information in a plurality of information storage frames arranged in a predetermined layout region. A movable region of the information storage frames on the layout region is set, and the layout section is set to move one of the information storage frames in the movable region relative to the other information storage frames.

With this configuration, the layout section stores listed information in the information storage frame, so that a layout is generated. In a layout process, the information storage frame is moved in the movable region relative to the other information storage frames.

Therefore, by permitting the designer to set a movable region beforehand for the necessary information storage frames, the information storage frames are moved in the region intended by the designer.

Hence, the designer's intention is more readily reflected on a layout. Further, since it is not necessary to set a reference line in the information storage frame, flexibility can be relatively improved for a layout.

In this case, the movable region may be set anywhere. For example, the movable region may be set in the information storage frame, listed information, or a layout template. Alternatively, the movable direction may be set as a program or an argument (the same applies hereinafter).

(Invention 4)

In the layout system of Invention 3, a layout system of Invention 4 is characterized in that when the plurality of information storage frames overlap each other with the listed information stored in the information storage frames, the layout section moves at least one of the plurality of overlapping information storage frames in the movable region of the information storage frames with the plurality of overlapping information storage frames not overlapping each other.

With this configuration, the layout section stores the listed information in the plurality of information storage frames, so that a layout is generated. When the plurality of information storage frames overlap each other as a result of storing the listed information, since the movable regions are set for the information storage frames, the layout section moves the overlapping information storage frames in the movable region so that the information storage frames do not overlap each other.

Therefore, by permitting the designer to set a movable region beforehand for the necessary information storage frames, in the case where the plurality of information storage frames overlap each other, the information storage frames are moved in the region intended by the designer and listed information is stored in the information storage frames so that the information storage frames do not overlap each other.

Hence, the designer's intention is more readily reflected on a layout. Further, since it is not necessary to set a reference line in the information storage frame, flexibility can be relatively improved for a layout. Moreover, a relatively proper layout can be obtained regardless of the contents of listed information, an amount of information, and a logical structure.

(Invention 5)

A layout system of Invention 5 comprises listed information storage section for storing two or more pieces of listed information, listed information selecting section for selecting desired listed information from the listed information registered in the listed information storage section, and layout section for laying out the listed information selected by the listed information selecting section. The layout section generates a layout by storing the listed information in a plurality of information storage frames arranged in a predetermined layout region, and the layout system further comprises template storage section for, regarding the predetermined layout region, storing a template for specifying a matter about the information storage frames arranged in the layout region. The template can set a movable direction along which the information storage frame moves on the layout region. The layout section stores the listed information in the plurality of information storage frames according to the template of the template storage section. When the plurality of information storage frames overlap each other with the listed information stored in the information storage frames, the layout section is set to move at least one of the plurality of overlapping information storage frames along the movable direction of the information storage frames based on the setting on the movable direction in the template.

With this configuration, listed information is selected from the listed information storage section by the listed information selecting section, and the selected listed information is stored in the plurality of information storage frames by the layout section, so that a layout is generated. When the plurality of information storage frames overlap each other as a result of storing the listed information, since the movable direction is set in the template, the layout section moves the overlapping information storage frames along the movable direction based on the setting on the movable direction in the template so that the information storage frames do not overlap each other.

Therefore, by permitting the designer to set a movable direction beforehand for the necessary information storage frames, in the case where the plurality of information storage frames overlap each other, the information storage frames are moved along the direction intended by the designer, so that listed information is stored in the information storage frames without permitting the information storage frames to overlap each other.

Hence, the designer's intention is more readily reflected on a layout. Further, since it is not necessary to set a reference line in the information storage frame, flexibility can be relatively improved for a layout. Moreover, a relatively proper layout can be obtained regardless of the contents of listed information, an amount of information, and a logical structure.

The listed information storage section stores listed information by using every means in every period. The listed information may be stored beforehand or may be stored by input from the outside during the operation of a main system. This applies when a template is stored in the template storage section.

(Invention 6)

In the layout system of Invention 5, a layout system of Invention 6 is characterized in that the template is a page template for specifying, regarding the layout region constituting a page, at least one of the shape, size, or arrangement of the information storage frame arranged in the layout region.

With this configuration, the layout section stores listed information in the plurality of information storage frames on each page, so that a layout is generated. Thus, the layout can be changed on each page.

(Invention 7)

In the layout system of Invention 6, a layout system of Invention 7 is characterized in that the movable direction is at least one of a first direction in a layout plane, a second direction opposed to the first direction, a third direction, and a fourth direction, the third and fourth directions being opposed to each other and perpendicular to the first and second directions.

With this configuration, when the plurality of information storage frames overlap each other as a result of storing listed information in the information storage frames, the layout section moves the overlapping information storage frames along at least one of the upper direction, the downward direction, the left direction, and the right direction so that the information storage frames do not overlap each other. Thus, the information storage frames can be moved in a desired direction.

(Invention 8)

In the layout system of Invention 6 or 7, a layout system of Invention 8 is characterized in that the plurality of different movable directions for one information storage frame can be set in the page template, the layout section is set to move the information storage frames along one of the plurality of movable directions, and when the information storage frames still overlap each other, the layout section is set to move the information storage frames along another direction of the plurality of movable directions.

With this configuration, the layout section moves the information storage frames along one of the plurality of movable directions. When the information storage frames still overlap each other as a result of the movement, the layout section moves the information storage frames along another direction of the plurality of movable directions.

Therefore, by permitting the designer to set a plurality of different movable directions beforehand for the necessary information storage frames, when the plurality of information storage frames overlap each other, even if the information storage frames cannot move along one direction intended by the designer, the information storage frames are moved along another direction intended by the designer, thereby storing listed information in the information storage frames without permitting the information storage frames to overlap each other.

Hence, the information storage frame is moved along another direction intended by the designer and thus flexibility can be further improved for a layout.

(Invention 9)

In the layout system of Invention 8, a layout system of Invention 9 is characterized in that a priority order is set for the plurality of movable directions, and the layout section is set to move the information storage frames along a direction having the highest priority of the plurality of movable directions, and the layout section is set to move the information storage frames along a direction having the second highest priority of the plurality of movable directions when the information storage frames still overlap each other.

With this configuration, the layout section moves the information storage frames along the direction having the highest priority of the plurality of movable directions. When the plurality of information storage frames still overlap each other as a result of the movement, the layout section moves the information storage frames along the direction having the second highest priority of the plurality of movable directions.

Therefore, by permitting the designer to set a plurality of different movable directions and its priority order beforehand for the necessary information storage frames, in the case where the plurality of information storage frames overlap each other, the directions are sequentially selected according to the priority order intended by the designer and the information storage frames are moved along the directions, and listed information is stored in the information storage frames without permitting the information storage frames to overlap each other.

Hence, the designer's intention is more readily reflected on a layout and a more proper layout can be obtained regardless of the contents of listed information, an amount of information, and a logical structure.

(Invention 10)

In the layout system of any one of Inventions 6 to 9, a layout system of Invention 10 is characterized in that the common movable direction for the plurality of information storage frames can be set in the page template, and when any one of the plurality of information storage frames, which has the set common movable direction, overlaps another information storage frame with the listed information stored in the information storage frames, the layout section is set to move the plurality of information storage frames, which have the set common movable direction, along the common movable direction.

With this configuration, when any one of the plurality of information storage frames, which has the set common movable direction, overlaps another information storage frame as a result of storing the listed information in the information storage frames, the layout section moves the plurality of information storage frames, which have the set common movable direction, along the common movable direction so that the information storage frames do not overlap each other.

Therefore, by permitting the designer to set a common movable direction beforehand for a plurality of related information storage frames, in the case where any one of the information storage frames overlaps another information storage frame, the information storage frames are integrally moved along the direction intended by the designer, and listed information is stored in the information storage frames without permitting the information storage frames to overlap each other.

Hence, the designer's intention is more readily reflected on a layout and a more proper layout can be obtained regardless of the contents of listed information, an amount of information, and a logical structure.

Another information storage frame may belong to the plurality of information storage frames having the set common movable direction, or maybe an information storage frame other than the plurality of information storage frames having the set common movable direction. Further, when the plurality of information storage frames having the set common movable direction are moved, the information storage frames are moved integrally. The information storage frames may be all moved with an equal movement amount or may be moved with different movement amounts.

(Invention 11)

In the layout system of Invention 10, the layout system of Invention 11 is characterized in that the plurality of different common movable directions for the plurality of information storage frames can be set in the page template, the layout section is set to move the plurality of information storage frames along one of the plurality of common movable directions, and when the information storage frames still overlap each other, the layout section is set to move the plurality of information storage frames along another direction of the plurality of common movable directions with the information storage frames not overlapping each other.

With this configuration, the layout section moves the plurality of information storage frames along one of the plurality of common movable directions. When the information storage frames still overlap each other as a result of the movement, the layout section moves the plurality of information storage frames along another direction of the plurality of common movable directions.

Therefore, by permitting the designer to set a plurality of different common movable directions beforehand for a plurality of related information storage frames, in the case where any one of the information storage frames overlaps another information storage frame, even if the information storage frames cannot be moved along the direction intended by the designer, the information storage frames are moved along another direction intended by the designer and listed information is stored in the information storage frames without permitting the information storage frames to overlap each other.

Thus, flexibility can be further improved for a layout.

(Invention 12)

A layout system of Invention 12 comprises listed information storage section for storing two or more pieces of listed information, listed information selecting section for selecting the desired listed information from the listed information registered in the listed information storage section, and layout section for laying out the listed information selected by the listed information selecting section. The layout section generates a layout by storing the listed information in a plurality of information storage frames arranged in a predetermined layout region. The layout system comprises template storage section for, regarding the predetermined layout region, storing a template for specifying a matter about the information storage frames arranged in the layout region. The template can set a movable region in which the information storage frame moves on the layout region. The layout section stores the listed information in the plurality of information storage frames according to the template of the template storage section. When the plurality of information storage frames overlap each other with the listed information stored in the information storage frames, the layout section is set to move at least one of the overlapping information storage frames in the movable region of the information storage frames based on the setting on the movable region in the template.

With this configuration, the listed information selecting section selects listed information from the listed information storage section and the layout section stores the selected listed information in the plurality of information storage frames, so that a layout is generated. When the plurality of information storage frames overlap each other as a result of storing the listed information, since the movable region is set in the template, the layout section moves the overlapping information storage frames in the movable region based on the setting on the movable region in the template so that the information storage frames do not overlap each other.

Therefore, by permitting the designer to set a movable region beforehand for the necessary information storage frames, in the case where the plurality of information storage frames overlap each other, the information storage frames are moved in the region intended by the designer and the listed. information is stored in the information storage frames without permitting the information storage frames to overlap each other.

Hence, the designer's intention is more readily reflected on a layout. Further, since it is not necessary to set a reference line in the information storage frame, flexibility can be relatively improved for a layout. Moreover, a relatively proper layout can be obtained regardless of the contents of listed information, an amount of information, and a logical structure.

(Invention 13)

In the layout system of Invention 12, a layout system of Invention 13 is characterized in that the template is a page template for specifying, regarding the layout region constituting a page, at least one of the shape, size, or position of the information storage frame arranged in the layout region.

With this configuration, the layout section stores listed information in the plurality of information storage frames on each page, so that a layout is generated. Thus, the layout can be changed on each page.

(Invention 14)

In the layout system of Invention 13, a layout system of Invention 14 is characterized in that the shape of the movable region is at least one of a rectangular shape, a circular shape, and other geometric shapes.

With this configuration, when the plurality of information storage frames overlap each other as a result of storing listed information in the information storage frames, the layout section moves the overlapping information storage frames in the rectangular region, the circular region, and other geometric regions so that the information storage frames do not overlap each other.

Hence, flexibility can be improved for a layout in the rectangular region, the circular region, and other geometric regions.

(Invention 15)

In the layout system of Invention 13 or 14, a layout system of Invention 15 is characterized in that a plurality of different movable regions for one information storage frame can be set in the page template, the layout section is set to move the information storage frame in one of the plurality of movable regions, and when the information storage frames still overlap each other, the layout section is set to move the information storage frame in another region of the plurality of movable regions.

With this configuration, the layout section moves the information storage frame in one of the plurality of movable regions. When the information storage frames still overlap each other as a result of the movement, the layout section moves the information storage frame in another region of the plurality of movable regions.

Therefore, by permitting the designer to set a plurality of different movable regions beforehand for the necessary information storage frames, in the case where the plurality of information storage frames overlap each other, even if the information storage frame cannot move in a region intended by the designer, the information storage frame is moved in another region intended by the designer and listed information is stored in the information storage frames without permitting the information storage frames to overlap each other.

Hence, the designer's intention is more readily reflected on a layout. Further, since it is not necessary to set a reference line in the information storage frame, flexibility can be relatively improved for a layout. Moreover, a relatively proper layout can be obtained regardless of the contents of listed information, an amount of information, and a logical structure.

(Invention 16)

In the layout system of Invention 15, a layout system of Invention 16 is characterized in that a priority order is set for the plurality of movable regions, the layout section is set to move the information storage frame in a region having the highest priority among the plurality of movable regions, and when the plurality of information storage frames still overlap each other, the layout section is set to move the information storage frame in a region having the second highest priority among the plurality of movable regions.

With this configuration, the layout section moves the information storage frame in the region having the highest priority among the plurality of movable regions. When the plurality of information storage frames still overlap each other as a result of the movement, the information storage frame is moved in the region having the second highest priority among the plurality of movable regions.

Therefore, by permitting the designer to set a plurality of movable regions and its priority order beforehand for the necessary information storage frames, in the case where the plurality of information storage frames overlap each other, the regions are sequentially selected according to the priority order intended by the designer, the information storage frames are moved in the regions, and listed information is stored in the information storage frames without permitting the information storage frames to overlap each other.

Hence, the designer's intention is more readily reflected on a layout. Further, since it is not necessary to set a reference line in the information storage frame, flexibility can be relatively improved for a layout. Moreover, a relatively proper layout can be obtained regardless of the contents of listed information, an amount of information, and a logical structure.

(Invention 17)

In the layout system of Invention 15 or 16, a layout system of Invention 17 is characterized in that the plurality of movable regions can be set across pages.

With this configuration, the layout section moves the information storage frame in one of the plurality of movable regions. When the plurality of information storage frames still overlap each other as a result of the movement, the layout section moves the information storage frame in another region of the plurality of movable regions across pages.

Hence, the designer's intention is more readily reflected on a layout. Further, since it is not necessary to set a reference line in the information storage frame, flexibility can be relatively improved for a layout. Moreover, a relatively proper layout can be obtained regardless of the contents of listed information, an amount of information, and a logical structure.

(Invention 18)

In the layout system of one of Inventions 13 to 17, a layout system of Invention 18 is characterized in that the common movable region for the plurality of information storage frames can be set in the page template, and when one of the plurality of information storage frames, which have the set common movable region, overlaps another information storage frame with the listed information stored in the information storage frames, the layout section is set to move the plurality of information storage frames, which have the set common movable region, in the common movable region.

With this configuration, when one of the plurality of information storage frames, which have the set common movable region, overlaps another information storage frame as a result of storing listed information in the information storage frames, the layout section moves the plurality of information storage frames, which have the set common movable region, in the common movable region so that the information storage frames do not overlap each other.

Therefore, by permitting the designer to set a common movable region beforehand for the plurality of related information storage frames, in the case where one of the information storage frames overlaps another information storage frame, the information storage frames are integrally moved in the region intended by the designer and listed information is stored in the information storage frames without permitting the information storage frames to overlap each other.

Hence, the designer's intention is more readily reflected on a layout. Further, since it is not necessary to set a reference line in the information storage frame, flexibility can be relatively improved for a layout. Moreover, a relatively proper layout can be obtained regardless of the contents of listed information, an amount of information, and a logical structure.

Another information storage frame may belong to the plurality of information storage frames having the set common movable region, or may be an information storage frame other than the plurality of information storage frames having the set common movable region. Moreover, when the plurality of information storage frames having the set common movable region are moved, the information storage frames are moved integrally. All the information storage frames may be moved with an equal movement amount or may be moved with different movement amounts.

(Invention 19)

In the layout system of Invention 18, a layout system of Invention 19 is characterized in that a plurality of different common movable regions for the plurality of information storage frames can be set in the page template, the layout section is set to move the plurality of information storage frames in one of the plurality of common movable regions, and when the information storage frames still overlap each other the layout section is set to move the plurality of information storage frames in another region of the plurality of common movable regions with the information storage frames not overlapping each other.

With this configuration, the layout section moves the plurality of information storage frames in one of the plurality of common movable regions. When the information storage frames still overlap each other as a result of the movement, the layout section moves the plurality of information storage frames in another region of the plurality of common movable regions.

Therefore, by permitting the designer to set a plurality of different common movable regions beforehand for the plurality of related information storage frames, in the case where one of the information storage frames overlaps another information storage frame, even if the information storage frames cannot move in a region intended by the designer, the information storage frames are moved in another region intended by the designer and listed information is stored in the information storage frames without permitting the information storage frames to overlap each other.

Hence, flexibility can be relatively improved for a layout.

(Invention 20)

A layout system of Invention 20 comprises listed information storage section for storing two or more pieces of listed information, listed information selecting section for selecting the listed information from the listed information storage section, and layout section for laying out the listed information selected by the listed information selecting section. The layout section generates a layout by storing the listed information in a plurality of information storage frames arranged in a predetermined layout region. The layout system comprises template storage section for, regarding the predetermined layout region, storing a template for specifying a matter about the information storage frames arranged in the layout region. The template can set a movable direction along which the information storage frame moves on the layout region, and a movable region. The layout section stores the listed information in the plurality of information storage frames according to the template of the template storage section. When the plurality of information storage frames overlap each other, the layout section is set to move the overlapping information storage frames in the movable region along the movable direction based on the setting on the movable direction and the movable region in the template to a position where the information storage frames do not overlap each other.

With this configuration, the listed information selecting section selects listed information from the listed information storage section and the layout section stores the selected listed information in the plurality of information storage frames, so that a layout is generated. When the plurality of information storage frames overlap each other as a result of storing the listed information, since the movable direction and the movable region are set in the template, the layout section moves the overlapping information storage frames in the movable region along the movable direction based on the setting on the movable direction and the movable region in the template so that the information storage frames do not overlap each other.

Therefore, by permitting the designer to set a movable direction and a movable region beforehand for the necessary information storage frames, in the case where the plurality of information storage frames overlap each other, the information storage frames are moved in the region and along the direction that are intended by the designer and the listed information is stored in the information storage frames without permitting the information storage frames to overlap each other.

Hence, flexibility can be relatively improved for a layout.

(Invention 21)

In the layout system of any of Inventions 5 to 20, a layout system of Invention 21 comprises user information storage section for storing user information about the user. The listed information selecting section selects the listed information from the listed information storage section based on the user information of the user information storage section.

With this configuration, the listed information selecting section selects the listed information from the listed information storage section based on the user information of the user information storage section. Hence, it is possible to generate listed contents relatively in compliance with the request of the user.

The user information includes the age, gender, taste, address, and name of the user, or the environment of a user terminal (the same applies hereinafter).

Further, the user information storage section may store user information by every means in every period. The user information may be stored beforehand or may be stored by input from the outside during the operation of a main system (the same applies hereinafter).

(Invention 22)

In the layout system of one of Inventions 5 to 20, a layout system of Invention 22 comprises user information storage section for storing user information about the user. The layout section lays out listed information, which is selected by the listed information selecting section, based on the user information of the user information storage section.

With this configuration, the layout section lays out selected listed information based on the user information of the user information storage section. Hence, layout results can be generated relatively in compliant with the request of the user.

In a layout generated based on user information, when the user information includes an age, a layout with a relatively large font size may be adopted for a relatively elderly user. Further, when the user information includes a gender, a layout with a round font may be adopted for a woman.

When the user information includes a taste, a layout of a kid's magazine, a sports newspaper, or a technical document may be adopted in compliance with the taste. When the user information includes an address, a layout with a background image of scenery specific to the region of the address may be adopted. When the user information includes a name, a layout with a title having the name may be adopted. When the user information includes the environment of the user terminal, a layout may be adopted which minimizes the use of an image with a large data capacity when the RAM of the user terminal has a small capacity.

(Invention 23)

In order to attain the above-described objective, a layout program of Invention 23 is a program for causing a computer to perform processing realized as a layout section of the layout system. When the plurality of information storage frames overlap each other with the listed information stored in the information storage frames, the layout section moves at least one of the plurality of overlapping information storage frames along a movable direction of the information storage frames with the plurality of overlapping information storage frames not overlapping each other.

Further, a layout program of Invention 23 is a program for causing a computer to perform processing realized as the layout section of the layout system of Invention 2. When the plurality of information storage frames overlap each other as a result of storing the listed information in the information storage frames, the layout section moves the overlapping information storage frames along a movable direction so that the information storage frames do not overlap each other.

With this configuration, when the program is read by the computer and the computer performs the processing according to the read program, the same function as the layout system of Invention 2 is realized on software. Hence, a general-purpose PC and so on can be used as it is without using any device such as special hardware, achieving high cost efficiency for practical use.

(Invention 24)

A layout program of Invention 24 is a program for causing a computer to perform processing realized as a layout section of the layout system. When the plurality of information storage frames overlap each other with the listed information stored in the information storage frames, the layout section moves at least one of the plurality of overlapping information storage frames in a movable region of the information storage frames with the plurality of overlapping information storage frames not overlap each other.

Further, a layout program of Invention 24 is a program for causing a computer to perform processing realized as the layout section of the layout system of Invention 4. When the plurality of information storage frames overlap each other as a result of storing the listed information in the information storage frames, the layout section moves the overlapping information storage frames in a movable region so that the information storage frames do not overlap each other.

With this configuration, as with Invention 23, when the program is read by the computer and the computer performs the processing according to the read program, the same operation/working effect as the layout system of Invention 4 is realized.

(Invention 25)

In order to attain the above-described objective, the layout method of Invention 25 comprises a layout step of laying out listed information. The layout step generates a layout by storing the listed information in a plurality of information storage frames arranged in a predetermine layout region. The layout method includes a movable direction setting step of setting a movable direction of the information storage frames on the layout region. When the plurality of information storage frames overlap each other with the listed information stored in the information storage frames, the layout step moves at least one of the plurality of overlapping information storage frames along the movable direction of the information storage frames.

Hence, like Invention 2, the designer's intention is more readily reflected on a layout and flexibility is improved for a layout.

(Invention 26)

A layout method of Invention 26 comprises a layout step of laying out listed information. The layout step generates a layout by storing the listed information in a plurality of information storage frames arranged in a predetermine layout region. The layout method includes a movable region setting step of setting a movable region of the information storage frames on the layout region. When the plurality of information storage frames overlap each other with the listed information stored in the information storage frames, the layout step moves at least one of the plurality of overlapping information storage frames in the movable region of the information storage frames.

Hence, like Invention 2, the designer's intention is more readily reflected on a layout and flexibility is improved for a layout.

(Invention 27)

In order to attain the above-described objective, a layout system of Invention 27 comprises layout section for generating a layout by arranging a plurality of information storage frames movably on a layout region and storing listed information in the information storage frames. The layout section forms the information storage frames into a group and is set to move at least one of the information storage frames belonging to the same group so as to have a predetermined relative positional relationship with each other.

Therefore, by storing two or more pieces of related listed information in the information storage frames constituting the group, even if one of the information storage frames needs to be moved on the layout region relative to the allocated information storage frames and so on, the other information storage frames belonging to the same group are also moved at the same time, so that the relative positional relationship is not considerably changed.

As a result, a desired layout is not seriously impaired, the designer's intention can be always reflected on a layout, and flexibility is increased for a layout.

(Invention 28)

A layout system of Invention 28 comprises layout section for generating a layout by arranging a plurality of information storage frames movably on a layout region and storing listed information in the information storage frames. The layout section forms the information storage frames into a group, arranges the information storage frames, which belong to the group, laterally along a paper surface direction on the layout region, and moves some or all of the information storage frames vertically so as to align the upper ends or lower ends, so that a layout is generated.

With this configuration, even if one information storage frame needs to be moved relative to the allocated information storage frame, the upper ends or lower ends are aligned all the time, so that it is possible to positively obtain a layout intended by the designer, e.g., “the upper ends or lower ends of the information storage frames are aligned.”

(Invention 29)

A layout system of Invention 29 comprises layout section for generating a layout by arranging a plurality of information storage frames movably on a predetermined layout region and storing listed information in the information storage frames. The layout section forms the information storage frames into a group, arranges the information storage frames, which belong to the same group, vertically on the layout region, and is set to move some or all of the information storage frames laterally so as to align the right ends or left ends, so that a layout is generated.

With this configuration, the right ends or left ends are similarly aligned all the time, so that it is possible to positively obtain a layout intended by the designer, e.g., “the right ends or left ends of the information storage frames are aligned.”

(Invention 30)

A layout system of Invention 30 comprises layout section for generating a layout by arranging a plurality of information storage frames movably on a layout region and storing listed information, which is composed of a character string of horizontal writing, in the information storage frames. The layout section forms the information storage frames into a group, arranges the information storage frames, which belong to the same group, laterally on the layout region, and is set to move some or all of the information storage frames vertically so as to align the row positions, so that a layout is generated.

With this configuration, the row positions of the group are aligned all the time, so that it is possible to positively obtain a layout intended by the designer, e.g., “the row positions of the information storage frames are aligned.”

(Invention 31)

A layout system of Invention 31 comprises layout section for generating a layout by arranging a plurality of information storage frames movably on a layout region and storing listed information, which is composed of a character string of vertical writing, in the information storage frames. The layout section forms the information storage frames into a group, arranges the information storage frames, which belong to the same group, vertically on the layout region, and is set to move some or all of the information storage frames laterally so as to align the line positions, so that a layout is generated.

With this configuration, the line positions of the group are aligned all the time, so that it is possible to positively obtain a layout intended by the designer, e.g., “the line positions of the information storage frames are aligned.”

(Invention 32)

A layout system of Invention 32 comprises layout section for generating a layout by arranging a plurality of rectangular information storage frames movably on a layout region and storing listed information in the information storage frames. The layout section forms the information storage frames into a group, arranges the information storage frames, which belong to the same group, diagonally on the layout region, and moves some or all of the information storage frames so as to connect the corners, so that a layout is generated.

With this configuration, the information storage frames are aligned diagonally all the time while the corners are in contact with each other, so that it is possible to positively obtain a layout intended by the designer, e.g., “the corners of the information storage frames are aligned diagonally.”

(Invention 33)

In the layout system of any of Inventions 27 to 32, a layout system of Invention 33 is characterized in that the layout system is set so that the information storage frames are expandable or reducible according to an amount of the listed information, and when the positional relationship is changed by expansion or reduction, some or all of the information storage frames are further moved so as to have the original relative positional relationship, so that a layout is generated.

With this configuration, even when the size of the information storage frame is changed according to an amount of listed information, a desired positional relationship is readily restored and thus a layout intended by the designer can be positively obtained.

(Invention 34)

A layout system of Invention 34 comprises layout section for generating a layout by arranging a plurality of information storage frames movably on a layout region and storing listed information in the information storage frames. The layout section forms the information storage frames into a group, arranges the information storage frames, which belong to the same group, so as to have a relative positional relationship on the layout region, can expand or reduce the information storage frames according to an amount of the listed information, determines a relative positional relationship between the barycenters of the information storage frames before storing the listed information, and when the barycenter of the information storage frame serving as the reference is displaced by the expansion or reduction of the information storage frame, the layout section is set to displace the barycenters of the other information storage frames according to the displacement to maintain the predetermined relative positional relationship, so that a layout is generated.

With this configuration, even when an amount of listed information to be stored in the information storage frames is increased or reduced more than the originally scheduled amount and considerably changes the relative positions of the information storage frames, the predetermined relative positions can be restored with ease. Thus, it is possible to positively obtain a layout intended by the designer, e.g., “listed information has a predetermined relative positional relationship.”

(Invention 35)

In the layout system of Invention 34, a layout system of Invention 35 is characterized in that when the barycenter of the information storage frame serving as the reference is displaced and the other information storage frames accordingly move out of the layout region, the layout section is set to reduce a distance between the barycenters while maintaining a ratio of distances in the relative positional relationship of the information storage frames, so that a layout is generated.

With this configuration, even if an amount of listed information to be stored in the information storage frames is increased or reduced more than the originally scheduled amount and considerably changes the relative positions of the information storage frames, the predetermined relative positions can be restored with ease. Thus, it is possible to positively obtain a layout intended by the designer, e.g., “listed information has a predetermined relative positional relationship.”

(Invention 36)

In the layout system of one of Inventions 27 to 35, a layout system of Invention 36 is characterized in that when the information storage frames are moved, the layout section is set to move the information storage frames to a position where none of the information storage frames overlaps the allocated information storage frames of another group, so that a layout is generated.

With this configuration, without impairing the positional relationship of listed information in the group, it is possible to prevent an artificial layout in which overlapping is made with the allocated listed information.

(Invention 37)

In the layout system of one of Inventions 27 to 36, a layout system of Invention 37 is characterized in that the layout section is set to lay out the information storage frames based on a template for defining the layout of the listed information beforehand.

With this configuration, a desired layout can be readily obtained only by changing the template.

(Invention 38)

A layout program of Invention 38 for realizing the function of layout section by means of a computer, the layout section generating a layout by arranging a plurality of information storage frames movably on a layout region and storing listed information in the information storage frames. The layout section forms the information storage frames into a group and is set to move the information storage frames, which belong to the same group, so as to have a relative positional relationship with each other.

With this configuration, when the program is read by the computer and the computer performs processing according to the read program, the same function as the layout system of Inventions 27 to 36 can be realized on software. Thus, a general-purpose PC and so on can be used as it is without using any device such as special hardware, achieving high cost efficiency for practical use.

(Invention 39)

A layout program of Invention 39 for realizing the function of layout section by means of a computer, the layout section generating a layout by arranging a plurality of information storage frames movably on a layout region and storing listed information in the information storage frames. The layout section forms the information storage frames into a group, moves the information storage frames, which belong to the same group, so as to have a predetermined relative positional relationship, stores the listed information in the information storage frames, and when the information storage frame is expanded or reduced according to an amount of the stored listed information and changes the positional relationship, the layout section is set to move the information storage frames so as to have the predetermined relative positional relationship again, so that the listed information is laid out.

With this configuration, even when an amount of listed information to be stored in the information storage frames is increased or reduced more than the originally scheduled amount as in the above description, the relative positional relationship of listed information is not considerably impaired and a layout intended by the designer can be positively realized on software.

(Invention 40)

A layout method of Invention 40 is characterized in that a plurality of information storage frames, which are formed into a group, are arranged movably on a layout region, the information storage frames constituting the group are moved so as to have a predetermined relative positional relationship, and listed information is stored in the information storage frames, so that listed information is laid out.

With this layout method, like the above-described layout systems and programs, even when one of the information storage frames needs to be moved, the relative positional relationship is not considerably changed, thereby reflecting the designer's intention directly on a layout all the time.

(Invention 41)

A layout method of Invention 41 is characterized in that a plurality of information storage frames, which are formed into a group, are arranged movably on a layout region, the information storage frames constituting the group are moved so as to have a predetermined relative positional relationship, listed information is stored in the information storage frames, the information storage frames are expanded or reduced according to an amount of the listed information, and the information storage frames are moved so as to restore the relative positional relationship of the information storage frames, which have been changed by expansion or reduction, to the predetermined relative positional relationship, so that listed information is laid out.

With this layout method, even when an amount of listed information to be stored in the information storage frames is increased or reduced more than the originally scheduled amount as in the above description, the relative positional relationship of listed information is not considerably impaired and a layout intended by the designer can be secured.

### BRIEF DESCRIPTION OF THE DRAWINGS

FIG. 1 is a block diagram showing the configuration of a network system employing the present invention;

FIG. 2 is a functional block diagram showing the functional outline of a contents distribution terminal;

FIG. 3 is a block diagram showing the configuration of the contents distribution terminal;

FIG. 4 is a diagram showing the data structure of a user profile table;

FIG. 5 is a diagram showing a layout state designated by a page template;

FIGS. 6A and 6B are diagrams showing the data structure of the page template;

FIG. 7 is a diagram sowing the data structure of a template application rule;

FIG. 8 is a diagram showing the data structure of the template application rule;

FIG. 9 is a diagram showing the data structure of a layout No. correspondence table;

FIGS. 10A and 10B are diagrams showing the data structure of a digital contents and category correspondence table;

FIG. 11 is a flowchart showing user registration;

FIG. 12 is a flowchart showing contents distribution;

FIG. 13 is a flowchart showing automatic layout;

FIG. 14 is a flowchart showing an operation of storing a selected article according to Embodiment 1;

FIGS. 15A to 15D are diagrams showing a layout process according to Embodiment 1;

FIG. 16 is a diagram showing the data structure of a page template according to Embodiment 2;

FIG. 17 is a flowchart showing an operation of storing a selected article according to Embodiment 2;

FIGS. 18A to 18D are diagrams for explaining a layout process according to Embodiment 2;

FIG. 19 is a flowchart showing an operation of storing a selected article according to Embodiment 3;

FIGS. 20A to 20C are diagrams for explaining a layout process according to Embodiment 3;

FIG. 21 is a flowchart showing an operation of storing a selected article according to Embodiment 4;

FIGS. 22A to 22C are diagrams for explaining a layout process according to Embodiment 4;

FIG. 23 is a flowchart showing an operation of storing a selected article according to Embodiment 5;

FIG. 24 is a diagram showing the data structure of a page template according to Embodiment 5;

FIG. 25 is a diagram showing a layout region according to Embodiment 5;

FIGS. 26A to 26D are diagrams for explaining a layout process according to Embodiment 5;

FIG. 27 is a flowchart showing an operation of storing a selected article according to Embodiment 6;

FIG. 28 is a diagram showing the data structure of a page template according to Embodiment 6;

FIGS. 29A to 29C are diagrams for explaining a layout process according to Embodiment 6;

FIG. 30 is a diagram showing another example of the data structure of a page template according to Embodiment 6;

FIG. 31 is a flowchart showing an operation of storing a selected article according to Embodiment 7;

FIG. 32 is a diagram showing the data structure of a page template according to Embodiment 7; and

FIGS. 33A to 33F are diagrams for explaining a layout process according to Embodiment 7.

### DETAILED DESCRIPTION OF THE PREFERRED EMBODIMENTS

Embodiment 1 of the present invention will be described below in accordance with the accompanying drawings.

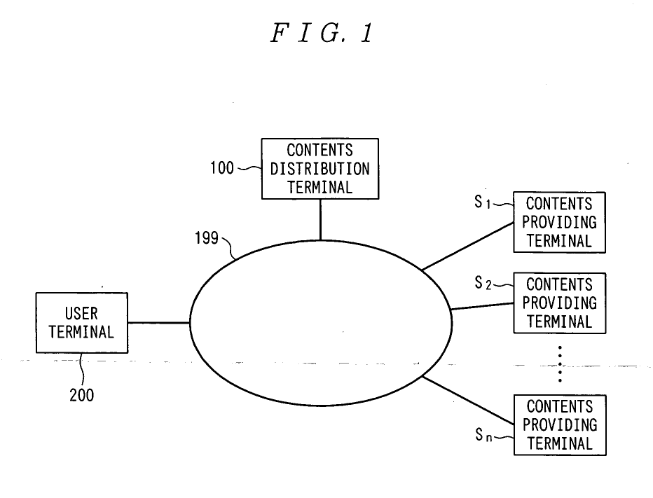

FIGS. 1 to 15 show Embodiment 1 of a layout system, a layout program, and a layout method according to the present invention.

In the present embodiment, the layout system, the layout program, and the layout method of the present invention are applied to the distribution of digital contents such as news from a contents distribution terminal 100 to a user terminal 200 as shown in FIG. 1.

Referring to FIG. 1, the following will firstly discuss the configuration of a network system employing the present invention. FIG. 1 is a block diagram showing the configuration of the network system employing the present invention.

As shown in FIG. 1, a plurality contents providing terminals S1 to Sn for providing digital contents, the contents distribution terminal 100 which collects, stores, and distributes digital contents provided from the contents providing terminals S1 to Sn (in some cases, digital contents provided from the contents providing terminals S1 to Sn will be referred to as article information or an article), and the user terminal 200 used by the user are connected to an Internet 199. For further understanding of the invention, a single user terminal 200 is shown. In reality, a plurality of user terminals are connected to the Internet 199.

The contents providing terminals S1 to Sn has the same function as a typical computer having a CPU, ROM, RAM, and I/F connected via a bus. When digital contents are generated, a category No. for specifying the category of digital contents is added to the digital contents and a transmission is made to the contents distribution terminal 100. The detail of the category No. will be described later.

The user terminal 200 has the same function as a typical computer having a CPU, ROM, RAM, and I/F connected via a bus. The user terminal 200 has a WWW (World Wide Web) browser by which access is made to the contents distribution terminal 100.

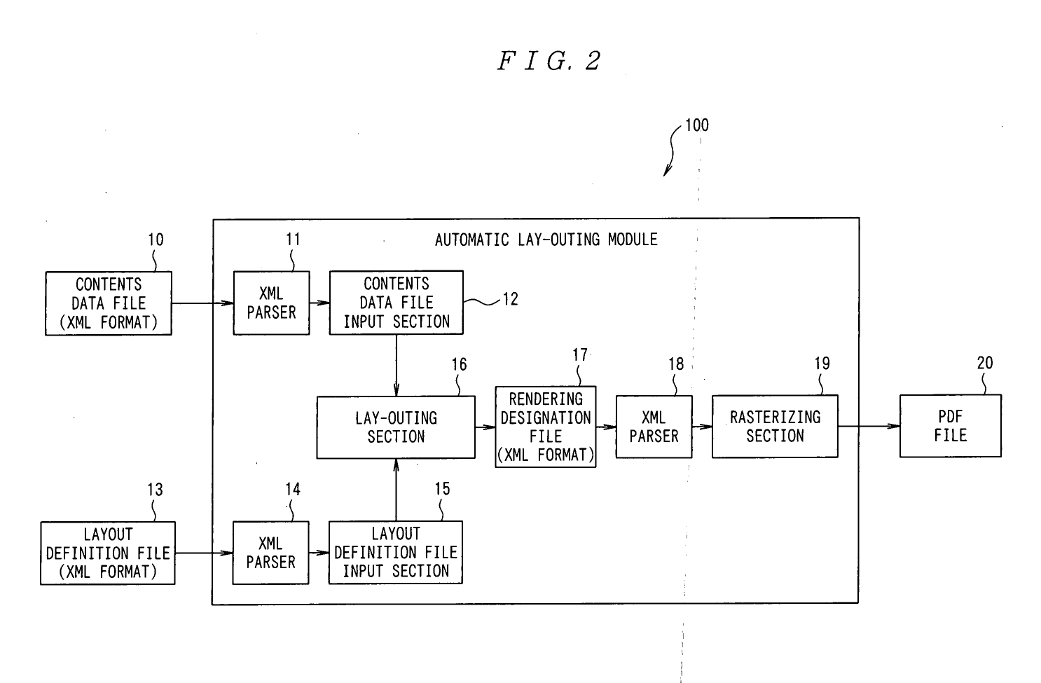

Referring to FIG. 2, the following will specifically describe the functional outline of the contents distribution terminal 100. FIG. 2 is a functional block diagram showing the functional outline of the contents distribution terminal 100.

As shown in FIG. 2, the contents distribution terminal 100 is constituted of an XML parser 11 for analyzing a contents data file 10 of XML (extensible Markup Language) format, a contents data file input section 12 for inputting the contents data file 10 analyzed by the XML parser 11, an XML parser 14 for analyzing a layout definition file (a page template and a template application rule which will be described later) 13 of XML format, a layout definition file input section 15 for inputting the layout definition file 13 analyzed by the XML parser 14, a lay-outing section 16 for generating a layout based on the content data file 10 inputted in the input sections 12 and 15 and the layout definition file 13, an XML parser 18 for analyzing a rendering designation file 17 of XML format from the lay-outing section 16, and a rasterizing section 19 for generating a file 20 of PDF (Portable Document Format) by performing rendering based on the rendering designation file 17 analyzed by the XML parser 18. The present embodiment is particularly characterized by the lay-outing section 16 of the constituent elements.

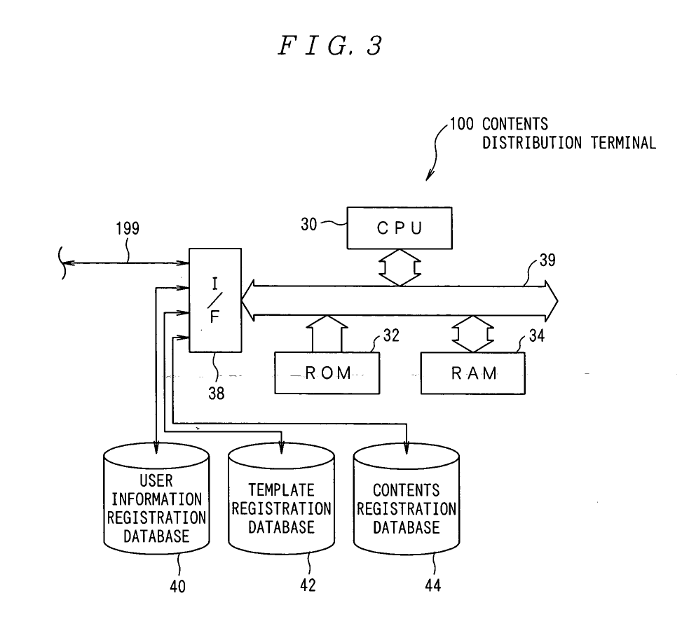

Referring to FIG. 3, the following will specifically describe the configuration of the contents distribution terminal 100. FIG. 3 is a block diagram showing the configuration of the contents distribution terminal 100.

As shown in FIG. 3, the contents distribution terminal 100 is constituted of a CPU 30 for controlling operations and the whole system based on a control program, a ROM 32 for storing the control program of the CPU 30 beforehand in a predetermined region, a RAM 34 for storing data read from the ROM 32 or the like and arithmetic results required for the processing of the CPU 30, and an I/F 38 for transmitting input/output of data to an external device. These constituent elements are connected to one another via a bus 39, which is a signal line for transferring data, so that data is transferred and received between the constituent elements.

External devices such as a user information registration DB 40 for registering user information, a template registration DB 42 for registering a page template, which specifies a layout framework for a layout region on each page, a contents registration DB 44 for collecting and storing digital contents provided from the contents providing terminals S1 to Sn, and a signal line for making a connection with the Internet 199 are connected to the I/F 38.

Subsequently, the data structure of the user information registration DB 40 will be discussed in detail in accordance with the accompanying drawings.

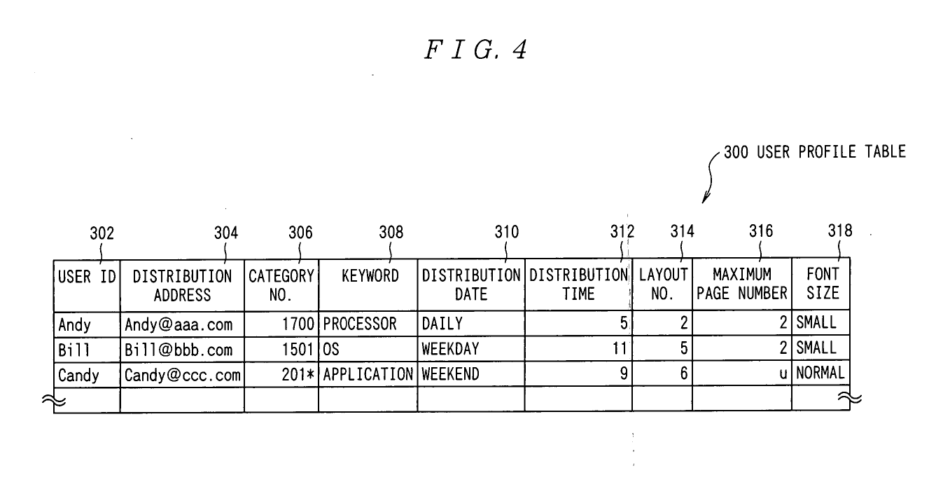

As shown in FIG. 4, a user profile table 300 for registering user information is stored in the user information registration DB 40. FIG. 4 is a diagram showing the data structure of the user profile table 300.

As shown in FIG. 4, the user profile table 300 can register one or more records for each user. Each record is constituted of a field 302 for registering a user ID for identifying a user, a field 304 for registering the distribution destination address of digital contents, a field 306 for registering a category No., a field 308 for registering a keyword, a field 310 for registering a distribution date, a field 312 for registering a distribution time, a field 314 for registering a layout No., a field 316 for registering the maximum number of pages, and a field 318 for registering a font size.

In the field 308, a keyword is registered when digital contents including the keyword specified by the user are selected as a distribution target. For example, the keyword is expected to frequently appear in an article of a category which interests the user. In the example of FIG. 4, “processor” is registered in the first row of the field 308 and “OS (operating System)” is registered in the second row of the field 308.

In the field 310, the user registers a requested distribution date for the distribution of digital contents. The distribution date to be specified includes “daily” indicating a request for daily distribution of digital contents, “weekday” indicating a request for weekday distribution, and “weekend” indicating a request for weekend distribution. In the example of FIG. 4, “daily” is registered in the first row of the field 310 and “weekday” is registered in the second row of the field 310.

In the field 312, a distribution time is registered which indicates a requested time for the distribution of digital contents on a distribution date specified by the user. The distribution time is any one of times expressed by 24 hours from 0 to 23 o'clock. In the example of FIG. 4, 5 o'clock is registered in the first row of the field 312 and 11 o'clock is registered in the second row of the field 312.

A layout No. for specifying an output layout of digital contents is registered in the field 314. For example, a layout No. is designated for specifying an output layout requested by the user. In the example of FIG. 4, layout No. 2 is registered in the first row of the field 314 and layout No. 5 is registered in the second row of the field 314. The layout No. will be described in detail later.

In the field 316, the maximum number of pages is registered that serves as the upper limit for displaying or printing digital contents. In addition to the maximum number of pages that serves as the upper limit, “u” is also specified which indicates that the upper limit is not set. In the example of FIG. 4, 2 pages is registered in the first row of the field 316 and “u” is registered in the third row of the field 316.

In the field 318, a font size is registered when digital contents are displayed or printed. In the example of FIG. 4, “small” is registered in the first row of the field 318 and “normal” is registered in the third row of the field 318.

Subsequently, the data structure of the template registration DB 42 will be discussed in detail in accordance with the accompanying drawings.

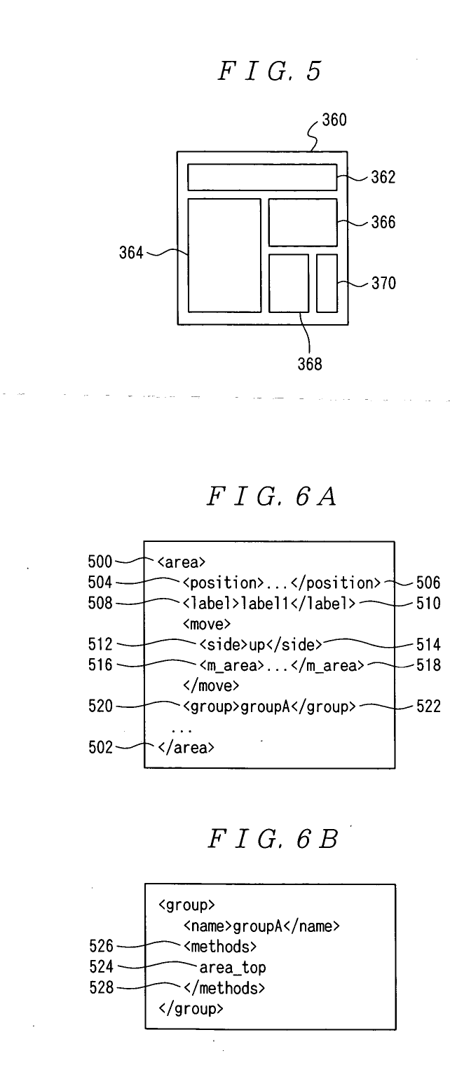

The template registration DB 42 stores a plurality of different page templates. Referring to FIGS. 5 and 6, the configuration of the page template will be discussed below. FIG. 5 shows a layout state specified by the page template. FIGS. 6A and 6B are diagrams showing the data structure of the page template.

As shown in FIG. 5, the page template specifies a layout state in which a title information storage frame 362 for storing title information, a character information storage frame 364 for storing character information, an image information storage frame 366 for storing image information, an image information storage frame 368, and a character information storage frame 370 are arranged on a layout region 360. Further, in some cases, a character information storage frame (not shown) only for storing character information overflowed from the character information storage frame (hereinafter, referred to as a flow object storage frame) is arranged in the layout region 360. As a matter of course, an unused character information storage frame may be used as the flow object storage frame. Hereinafter, character information overflowed from the character information storage frame and other overflowed information on the current page or the previous page will be referred to as a flow object. FIG. 5 shows just one example and thus the shape, the size, the number, or the position of the information storage frames in the layout region 360 is different for each page template.

As shown in FIG. 6A, in the page template, a layout format is set by describing a tag set of a start tag and an end tag between a predetermined start tag (e.g., <page>) and an end tag (e.g., </page>). The example of FIG. 6A describes a tag set of 500 and 502 for setting an information storage frame, a tag set of 504 and 506 for setting the position of the information storage frame, a tag set of 508 and 510 for setting the name of an information storage frame, a tag set of 512 and 514 for setting a movable direction along which the information storage frame can move on the layout region 360, a tag set of 516 and 518 for setting a movable region of the information storage frame on the layout region 360, and a tag set of 520 and 522 for setting a group to which the information storage frame belongs. “label1” is described by the tag set of 508 and 510, “up” is described by the tag set of 512 and 514, and “groupA” is described by the tag set of 520 and 522. This means that an information storage frame called “label1” is set, the information storage frame can move up in a movable region, and the information storage frame called “label1” belongs to a group called “groupA.” Further, the setting of the “groupA” is described in XML of FIG. 6B. The description means that the “groupA” has “area_top” set by the tag set of 526 and 528, that is, a movement is made while aligning the upper parts of the information storage frames. Unless otherwise specified, the movement of the information storage frame is performed while maintaining the size and shape of the information storage frame. This holds true in the following description.

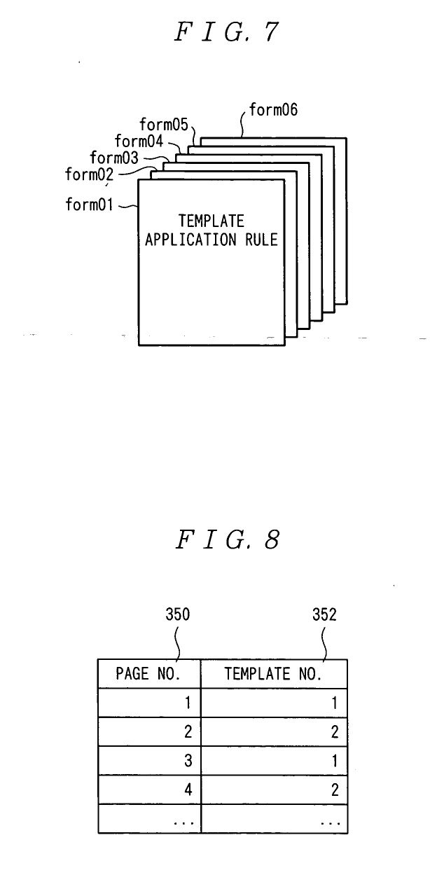

Further, as shown in FIG. 7, the template registration DB 42 stores a plurality of different template application rules form 01 to form 06. Referring to FIGS. 7 and 8, the configuration of the template application rule will be discussed below. FIGS. 7 and 8 are diagrams showing the data structure of the template application rule.

The template application rule specifies the rule of a template to be applied for each of the layout regions 360, on the assumption that layout results are obtained over the two or more layout regions 360. As shown in FIG. 8, the template application rule registers one record on each page. Each record is constituted of a field 350 for registering a page number and a field 352 for registering a template number for identifying a page template.

In the example of FIG. 8, “1” is registered as a page number and “1” is registered as a template number in the record of the first row. This means that a page template with a template number “1” should be used for the layout region 360 on page 1.

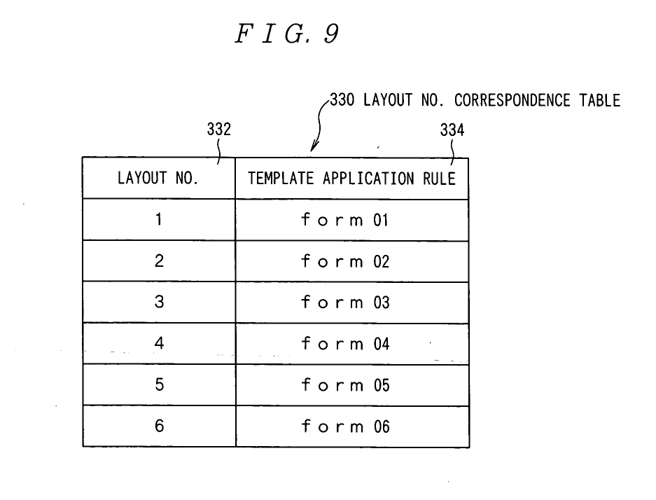

As shown in FIG. 9, the template registration DB 42 stores a layout No. correspondence table 330 indicating a correspondence relation between template application rules form 01 to form 06 and layout Nos. Referring to FIG. 9, the configuration of the layout No. correspondence table 330 will be discussed below. FIG. 9 is a, diagram showing the data structure of the layout No. correspondence table 330.

As shown in FIG. 9, one record is registered for each layout No. in the layout No. correspondence table 330. Each record includes a field 332 for registering layout Nos. and a field 334 for registering the names of the template application rules.

In the example of FIG. 9, “1” is registered as a layout No. and “form 01” is registered as a name of the template application rule in the record of the first row, and “2” is registered as a layout No. and “form 02” is registered as a name of the template application rule in the record of the second row.

The data structure of the contents registration DB 44 will be discussed in detail in accordance with the accompanying drawings.

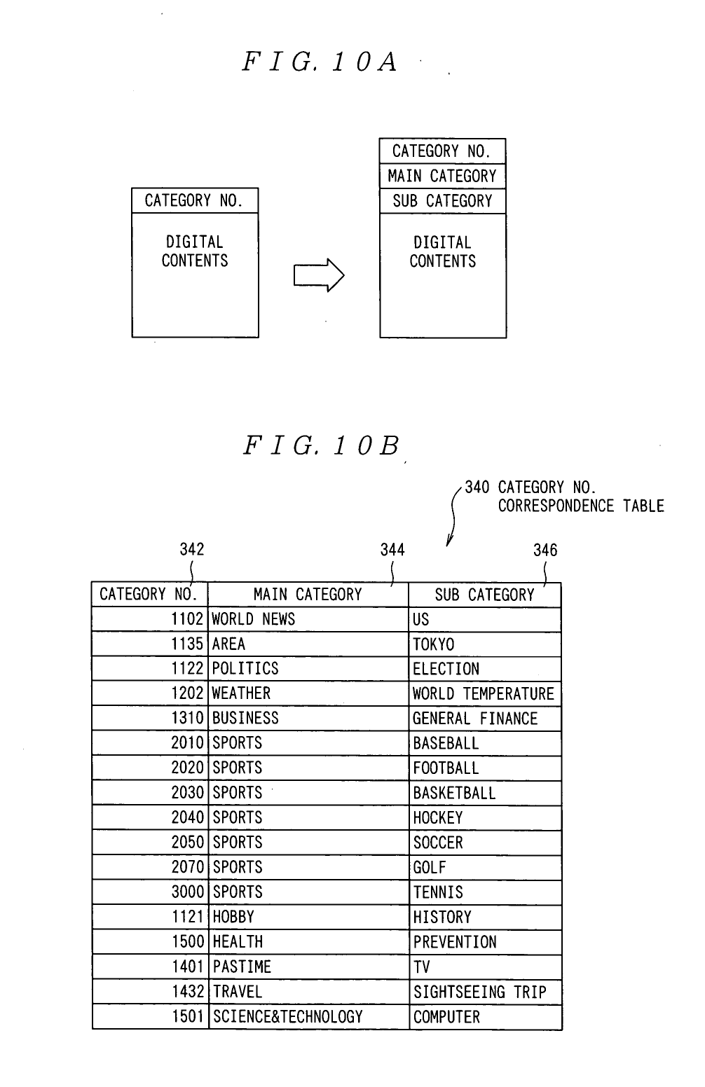

As shown in FIGS. 10A and 10B, the contents registration DB 44 registers digital contents provided from the contents providing terminals S1 to Sn and a category No. correspondence table 340 indicating a correspondence relation of a main category, a sub category, and a category No. FIGS. 10A and 10B are diagrams showing digital contents and the data structure of the category No. correspondence table 340.

As shown in FIG. 10A, the digital contents provided from the contents providing terminals S1 to Sn are indicated by an article number and category No. The contents distribution terminal 100 categorizes the digital contents for each category based on the category No. and registers the digital contents in the contents registration DB 44. Upon registration, with reference to the category No. correspondence table 340, a main category and a sub category as well as an article number and a category No. are added to the digital contents and then registration is performed. Moreover, the digital contents are constituted of one article including title information indicating the title of the article, image information about the image of the article, and character information about the sentences of the article.

As shown in FIG. 10B, one record is registered for each main category and sub category in the category No. correspondence table 340. Each record includes a field 342 for registering a category No., a field 344 for registering a main category, and a field 346 for registering a sub category.

In the example of FIG. 10B, “1102” is registered as a category No., “World News” is registered as a main category, and “US” is registered as a sub category in the record of the first row, and “2010” is registered as a category No., “Sports” is registered as a main category, and “Baseball” is registered as a sub category in the record of the sixth row.

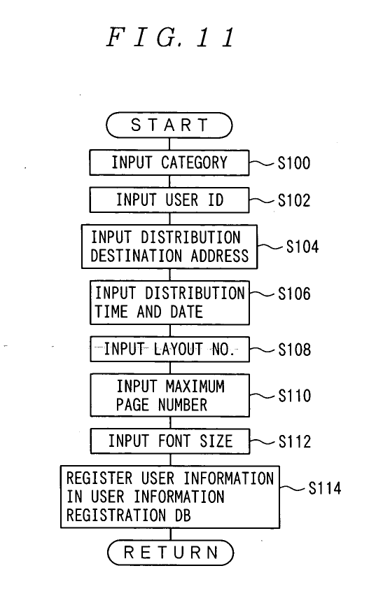

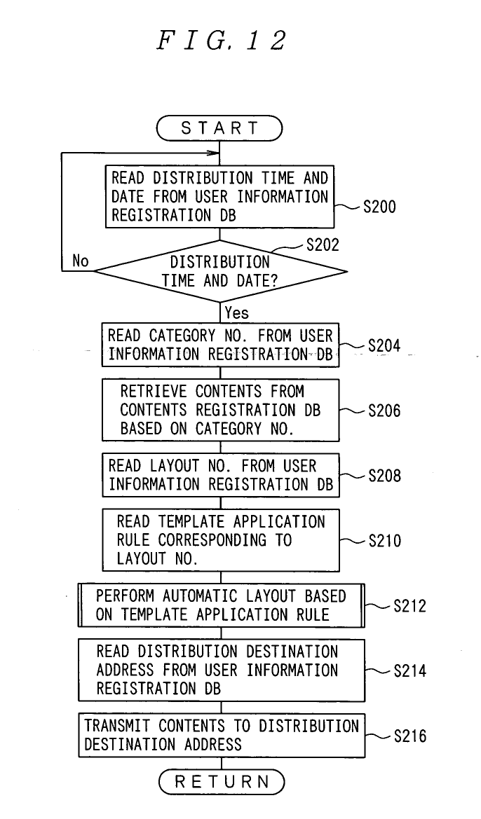

Referring to FIGS. 11 and 12, the following will describe the configuration of the CPU 30 and processing performed in the CPU 30.

The CPU 30 is constituted of a microprocessing unit MPU and so on. Predetermined programs stored in the predetermined region of the ROM 32 are started, and user registration and contents distribution shown in the flowcharts of FIGS. 11 and 12 are performed according to the programs based on time sharing.

Referring to FIG. 11, user registration will be firstly discussed in detail. FIG. 11 is a flowchart showing the user registration.

In the user registration, the user who makes access is requested to input necessary user information such as a user ID, and input user information is registered in the user profile table 300. When the registration is performed in the CPU 30, as shown in FIG. 11, a transition is made to step S100. Hereinafter, input is performed in each step by interactive communication with the user.

In step S100, a main category and a sub category are inputted and a transition is made to step S102. A user ID and a password are inputted and a transition is made to step S104. A distribution destination address is inputted and a transition is made to step S106. A distribution date and a distribution time are inputted and a transition is made to step S108.

In step S108, a layout No. is inputted and a transition is made to step S110. The maximum number of pages is inputted and a transition is made to step S112. A font size is inputted and a transition is made to step S114. User information inputted in steps S100 to S112 is registered in the user profile table 300. Thus, a series of processing is completed and a return is made to the original processing.

Referring to FIG. 12, contents distribution will be discussed in detail. FIG. 12 is a flowchart showing the contents distribution.

In the contents distribution, digital contents are distributed to the user terminal 200 with reference to the user profile table 300. When the distribution is performed in the CPU 30, firstly a transition is made to step S200 as shown in FIG. 12. Each step shows processing performed on a single record of the user profile table 300. In reality, the processing of each step is performed according to the number of records registered in the user profile table 300.

In step S200, a distribution date and a distribution time are read from the user profile table 300 and a transition is made to step S202 to decide whether or not digital contents should be distributed based on the read distribution date and distribution time. When it is decided that the digital contents should be distributed (Yes), a transition is made to step S204. When it is decided that digital contents should not be distributed (No), a transition is made to step S200.

In step S204, a category No. is read from the user profile table 300 and a transition is made to step S206. A search is performed on the digital contents of the contents registration DB 44 based on the read category No. Digital contents with a category No. matching the read category No. are retrieved and a transition is made to step S208.

In step S208, a layout No. is read from the user profile table 300 and a transition is made to step S210. A template application rule corresponding to the read layout No. is read from the template registration DB 42 with reference to the layout No. correspondence table 330 and a transition is made to step S212. Based on the read template application rule, automatic layout is performed to determine an output layout of the digital contents retrieved in step S206 and generate digital contents for provision, and a transition is made to step S214.

In step S214, a distribution destination address is read from the user profile table 300 and a transition is made to step S216. The generated digital contents for provision are distributed to the read distribution destination address. Thus, a series of processing is completed and a return is made to the original processing.

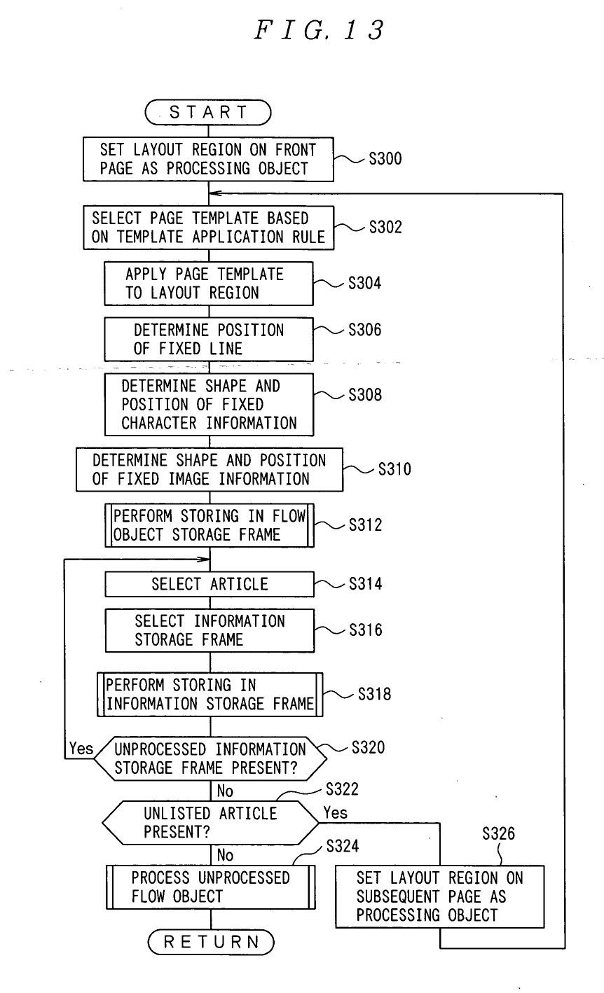

Referring to FIG. 13, the automatic layout of step S212 will be discussed in detail. FIG. 13 is a flowchart showing the automatic layout.

When the automatic layout is performed in step S212, a shift is firstly made to step S300 as shown in FIG. 13.

In step S300, the layout region 360 on the front page is set as a processing object and a transition is made to step S302. A page template is read from the template registration DB 42 based on the template application rule read in step S210 and a transition is made to step S304. The read page template is applied to the current layout region 360 and a transition is made to step S306.

In step S306, the position of a fixed line, which is arranged on a page in a fixed manner, is determined and a transition is made to step S308. The shape and position of fixed character information, which is arranged on a page in a fixed manner, are determined and a transition is made to step S310. The shape and position of fixed image information, which is arranged on a page in a fixed manner, are determined and a transition is made to step S312.

In step S312, the shape and position of a flow object storage frame are determined. A flow object is stored in the flow object storage frame and a transition is made to step S314. Based on a predetermined priority order, an article to be arranged in the layout region 360 is selected from the digital contents retrieved in step S206 and a transition is made to step S316.

In step S316, based on the predetermined priority order, an information storage frame is selected from the layout region 360 currently serving as a processing target (hereinafter simply referred to as a current layout region 360) and a transition is made to step S318. The article selected in step S314 (hereinafter simply referred to as a selected article) is stored in the information storage frame selected in step S316 and a transition is made to step S320.

In step S320, it is decided whether or not the current layout region 360 has unprocessed information storage frames. When it is decided that unprocessed information storage frames are absent (No), a transition is made to step S322. It is decided whether or not the digital contents retrieved in step S206 have unlisted articles. When it is decided that unlisted articles are absent (No), a transition is made to step S324 to list unprocessed flow objects. Thus, a series of processing is completed and a return is made to the original processing.

On the other hand, when it is decided that unlisted articles are present (Yes) in step S322, a transition is made to step S326. The layout region 360 on the subsequent page is set as a processing target and a transition is made to step S302.

On the other hand, when it is decided that the current layout region 360 has unprocessed information storage frames in step S320 (Yes), a transition is made to step S314.

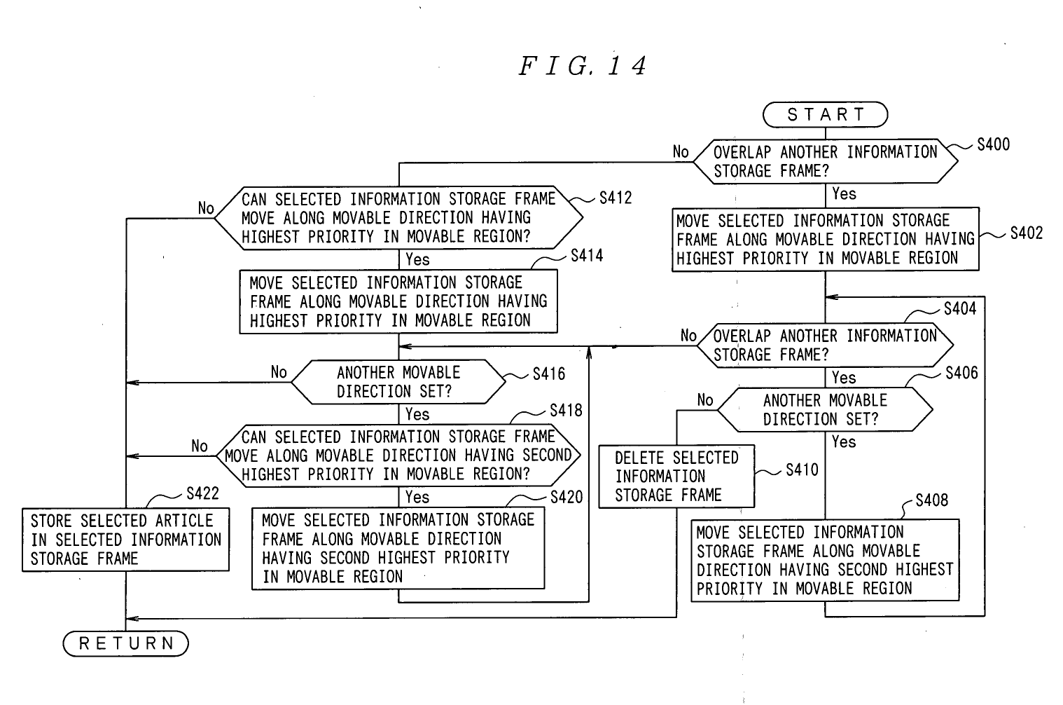

Referring to FIG. 14, the operation of storing a selected article in step S318 will be discussed in detail. FIG. 14 is a flowchart showing the operation of storing a selected article.

When a selected article is stored in step S318, a shift is firstly made to step S400 as shown in FIG. 14.

In step S400, it is decided whether or not a selected information storage frame overlaps another information storage frame. When it is decided that the selected information storage frame overlaps another information storage frame (Yes), a transition is made to step S402.

In step S402, the selected information storage frame is moved in a movable region along a movable direction having the highest priority and a transition is made to step S404. As a result of the movement, it is decided whether or not the selected information storage frame overlaps another information storage frame. When it is decided that the selected information storage frame overlaps another information storage frame (Yes), a transition is made to step S406.

In step S406, it is decided whether or not another movable direction is set in the selected information storage frame. When it is decided that another movable direction is set in the selected information storage frame (Yes), a transition is made to step S408. The selected information storage frame is moved in the movable region along a movable direction having the second highest priority and a transition is made to step S404.

On the other hand, when it is decided in step 406 that another movable direction is not set in the selected information storage frame (No), a transition is made to step S410 to delete the selected information storage frame. A series of processing is completed and a return is made to the original processing.

On the other hand, when it is decided in step S400 that the selected information storage frame does not overlap another information storage frame (No), a transition is made to step S412. It is decided whether or not the selected information storage frame can be moved in the movable region along the movable direction having the highest priority. When it is decided that the selected information storage frame can be moved in the movable region along the movable direction having the highest priority (Yes), a transition is made to step 414. Then, the selected information storage frame is moved in the movable region along the movable direction having the highest priority and a transition is made to step S416.

In step S416, it is decided whether or not another movable direction is set in the selected information storage frame. When it is decided that another movable direction is set in the selected information storage frame (Yes), a transition is made to step S418.

In step S418, it is decided whether or not the selected information storage frame can be moved in the movable region along the movable direction having the second highest priority. When it is decided that the selected information storage frame can be moved in the movable region along the movable direction having the second highest priority (Yes), a transition is made to step S420. Then, the selected information storage frame is moved in the movable region along the movable direction having the second highest priority and a transition is made to step S416.

On the other hand, when it is decided in step S418 that the selected information storage frame cannot be moved in the movable region along the movable direction having the second highest priority (No), a transition is made to step S422 to store the selected article in the selected information storage frame. Thus, a series of processing is completed and a return is made to the original processing.

On the other hand, when it is decided in step S416 that another movable direction is not set in the selected information storage frame (No) and when it is decided in step S412 that the selected information storage frame cannot be moved in the movable region along the movable direction having the highest priority (No), a transition is made to step S422.

On the other hand, in step S404, when it is decided that the selected information storage frame does not overlap another information storage frame (No), a transition is made to step S416.

The operations of the present embodiment will be firstly discussed below.

The following will firstly describe the registration of information required to distribute digital contents.

When the user requests the distribution of digital contents, the user makes access, in the user terminal 200, to the contents distribution terminal 100 via the WWW browser, and the user inputs a user registration request.

When the user registration request is inputted, the user terminal 200 requests the user to input necessary user information via communications with the contents distribution terminal 100. In response to the input request, the user inputs, as user information, a main category, a sub category, a user ID, a password, a distribution destination address, a distribution date, a distribution time, a layout No., the maximum number of pages, and a font size. Then, the user information is transmitted to the contents distribution terminal 100.

In the contents distribution terminal 100, when user information is received in response to a registration request, the received user information is registered in the user profile table 300 through steps S100 to S114.

The following will describe the distribution of digital contents with reference to the user profile table 300.

In the contents distribution terminal 100 which refers to the user profile table 300, at a time and date when digital contents should be distributed, a category No. is read from the user profile table 300, a search is performed on the digital contents of the contents registration DB 44 based on the read category No, and digital contents with a category No. matching the read category No. are retrieved through steps S204 and S206. Subsequently, through steps S208 to S212, a layout No. is read from the user profile table 300, a template application rule corresponding to the read layout No. is read from the user information registration DB 40 with reference to the layout No. correspondence table 330, and an output layout is determined for the retrieved digital contents based on the read template application rule, so that digital contents for provision are generated.

In the layout process, firstly through steps S300 to S304, the layout region 360 on the front page is set as a processing target, a page template is read from the template registration DB 42 based on the read template application rule, and the read page template is applied to the current layout region 360. Subsequently, through steps S306 to S314, the read page template is applied to the current layout region 360, and the position of a fixed line, the shape and position of fixed character information, and the shape and position of fixed image information are determined in this order.

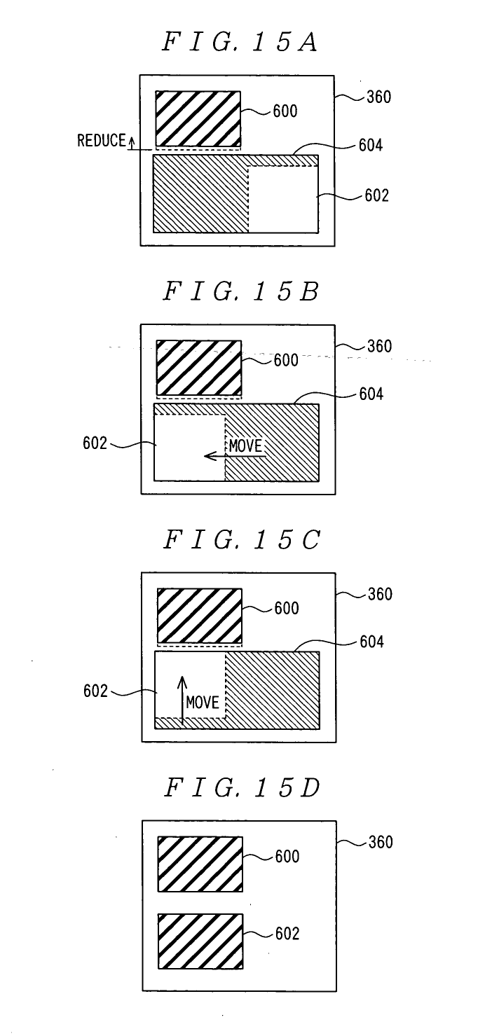

FIGS. 15A to 15D are diagrams for explaining the layout process. In the examples of FIGS. 15A to 15D, two articles are retrieved from the contents registration DB 44 and one of the articles is stored in an information storage frame 600. In this case, since the information storage frame 600 stores the article having a small amount of information, as shown in FIG. 15A, the lower side of the information storage frame 600 is shortened upward so as to reduce the information storage frame 600. Additionally, in an information storage frame 602, the lower half region of the layout region 360 is set as the movable region 604, the left direction is set as the movable direction having the first priority, and the upward direction is set as the movable direction having the second priority.

Subsequently, the information storage frame 602 is selected through step S316. Then, in the information storage frame 602, the left direction is set as the movable direction having the first priority and the information storage frame 602 can move in the left direction in the movable region 604. Thus, through steps S400, S412, and S414, as shown in FIG. 15B, the information storage frame 602 is moved in the left direction in the movable region 604 and is moved to the left end of the movable region 604.

Then, in the information storage frame 602, the upward direction is set as the movable direction having the second priority and the information storage frame 602 can move up in the movable region 604. Thus, through steps S416 to S412, as shown in FIG. 15C, the information storage frame 602 is moved up in the movable region 604 and is moved to the upper end of the movable region 604.

Since another movable direction is not set in the information storage frame 602, through steps S416 and S422, the other article is stored in the information storage frame 602, so that the layout of the information storage frame 602 is determined as shown in FIG. 15D.

Further, when an unprocessed information storage frame overlaps a processed information storage frame as a result of storing listed information in the information storage frame, the unprocessed information storage frame is selected and the selected information storage frame is moved in the movable region along the movable direction having the first priority through steps S316, S400, and S402. When the selected information storage frame still overlaps another information storage frame as a result of the movement, the selected information storage frame is moved in the movable region along the movable direction having the second priority through steps S404 to S408. When overlapping is eliminated with another information storage frame as a result of the movement, the selected article is stored in the selected information storage frame through step S422. In contrast, when overlapping is still made with another information storage frame, the selected information storage frame is moved in the movable region along the movable direction having the second highest priority. The information storage frame is moved until a movement along a movable direction having the lowest priority. When overlapping is still made with another information storage frame after movement along the movable direction having the lowest priority, the selected information storage frame is deleted through step S410.

Subsequently, when unprocessed information storage frames become absent in the layout region 360, the layout region 360 on the subsequent page is set as a processing target through steps S328, S400, and S406, and the same storing operation is repeated.

Then, the storing operation is repeated until unlisted articles become absent in digital contents retrieved in step S206. Thus, all the articles included in the retrieved digital contents are listed and the output layout of the digital contents is determined. When the output layout is determined, a distribution destination address is read from the user profile table 300 through steps S222 and S224, and the generated digital contents for provision are distributed to the read distribution destination address.

In this way, in the present embodiment, the movable direction of the information storage frame can be set in the page template, and the contents distribution terminal 100 stores articles in the plurality of information storage frames according to the page template of the template registration DB 42. When the plurality of information storage frames overlap each other as a result of the storing operation, the overlapping information storage frames are moved in the movable direction based on the setting on the movable direction in the page template so that the information storage frames do not overlap each other.

Hence, when the plurality of information storage frames overlap each other as a result of storing an article, the information storage frames are moved in a direction intended by the designer. Thus, as compared with the conventional art, the designer's intention is more readily reflected on a layout and a relatively proper layout can be obtained regardless of the contents of an article, an amount of information, and a logical structure. Further, it is not necessary to set a reference line in the information storage frame and thus flexibility can be relatively improved for a layout.

Moreover, in the present embodiment, a plurality of different movable directions for one information storage frame can be set in the page template. The contents distribution terminal 100 moves the information storage frame along any one of the plurality of movable directions. When the information storage frames still overlap each other as a result of the movement, the information storage frame is moved along another direction of the plurality of movable directions.

Therefore, in the case where a plurality of information storage frames overlap each other, even when the information storage frame cannot move along a direction intended by the designer, the information storage frame is moved along another direction intended by the designer, thereby further improving flexibility for a layout.

Moreover, in the present embodiment, priorities are set for a plurality of movable directions. The contents distribution terminal 100 moves the information storage frame along a direction having the highest priority among the plurality of movable directions. When the plurality of information storage frames still overlap each other as a result of the movement, the information storage frame is moved along a direction having the second highest priority among the plurality of movable directions.

Thus, when the plurality of information storage frames overlap each other, directions are sequentially selected according to the priority order intended by the designer and the information storage frame is moved along the selected directions. Hence, the designer's intention can be more readily reflected on a layout and a more proper layout can be obtained regardless of the contents of an article, an amount of information, and a logical structure.

Furthermore, in the present embodiment, a movable region for the information storage frame can be set in the page template. The contents distribution terminal 100 stores articles in the plurality of information storage frames according to the page template of the template registration DB 42. When the plurality of information storage frames overlap each other as a result of storing the articles, the overlapping information storage frames are moved in the movable region according to the setting on the movable region in the page template so that the information storage frames do not overlap each other.

Therefore, when the plurality of information storage frames overlap each other as a result of storing the articles, the information storage frames are moved in a region intended by the designer. Hence, as compared with the conventional art, the designer's intention can be more readily reflected on a layout and a relatively proper layout can be obtained regardless of the contents of an article, an amount of information, and a logical structure. Further, it is not necessary to set a reference line in the information storage frame and thus flexibility is relatively improved for a layout.

Further, in the present embodiment, the contents distribution terminal 100 retrieves digital contents from the contents registration DB 44 based on the user information of the user information registration DB 40.

Hence, the selection of digital contents refers to information specific to the user and information specified by the user, thereby generating digital contents for provision relatively in compliance with the requests of the user.

Moreover, in the present embodiment, the contents distribution terminal 100 determines an output layout of digital contents and generates digital contents for provision based on the user information of the user information registration DB 40.

Hence, the determination of an output layout refers to information specific to the user and information specified by the user, thereby generating digital contents for provision that has an output layout relatively in compliance with the requests of the user.

“Flow object” in the above embodiment refers to the portion of listed information that is overflowed from an information storage frame when the listed information is attempted to be stored in the information storage frame that is too small to lay out all of the listed information. Further, “flow object information frame” refers to an information storage frame for storing the overflowed information that is assigned for storing the overflowed listed information.

Further, this embodiment describes a layout template with the information storage frames not defined to be overlapped, like the layout template shown in FIG. 5, but not limited thereto, and may be one with the information storage frames to be overlapped. Therefore, for example, even when the information storage frame only contains a less listed information for a layout, forming redundant blank can be relatively easily inhibited.

Embodiment 2 of the present invention will be described below in accordance with the accompanying drawings.

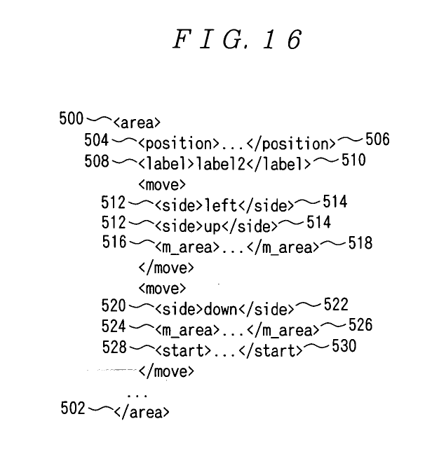

FIGS. 16 to 18 are diagrams showing Embodiment 2 of a layout system, a layout program, and a layout method according to the present invention.

In the present embodiment, the layout system, the layout program, and the layout method of the present invention are applied to the distribution of digital contents such as news from a contents distribution terminal 100 to a user terminal 200. The present embodiment is different from Embodiment 1 in that a plurality of different movable regions are set for one information storage frame. Hereinafter, only parts different from those of Embodiment 1 will be described. The same parts as Embodiment 1 are indicated by the same reference numerals and the explanation thereof is omitted.

Referring to FIG. 16, the configuration of a page template will be discussed in detail. FIG. 16 is a diagram showing the data structure of the page template.

As shown in FIG. 16, in the page template, a layout format is set by describing a tag set of a start tag and an end tag between a predetermined start tag (e.g., <page>) and an end tag (e.g., </page>). The example of FIG. 16 describes a tag set of 500 and 502 for setting an information storage frame, a tag set of 504 and 506 for setting the position and size of the information storage frame in a first movable region, a tag set of 508 and 510 for setting the name of the information storage frame, a tag set of 512 and 514 for setting a movable direction of the information storage frame in the first movable region, a tag set of 516 and 518 for setting the first movable region, a tag set of 520 and 522 for setting a movable direction of the information storage frame in a second movable region, a tag set of 524 and 526 for setting the second movable region, and a tag set of 528 and 530 for setting the starting position of arranging the information storage frame in the second movable region. “label2” is described by the tag set of 508 and 510, “left” and “up” are described by the tag set of 512 and 514, and “down” is described by the tag set of 520 and 522. This means that an information storage frame called “label2” is set, the information storage frame can move up and to the left in the first movable region and can move down in the second movable region. In this case, the plurality of movable regions are set and a region described at the front has the highest priority. Namely, the information storage frame is moved in the first movable region and the position is determined thereon when the information storage frame does not overlap another information storage frame. When the information storage frame still overlaps another information storage after the movement, the information storage frame is moved in the second movable region.

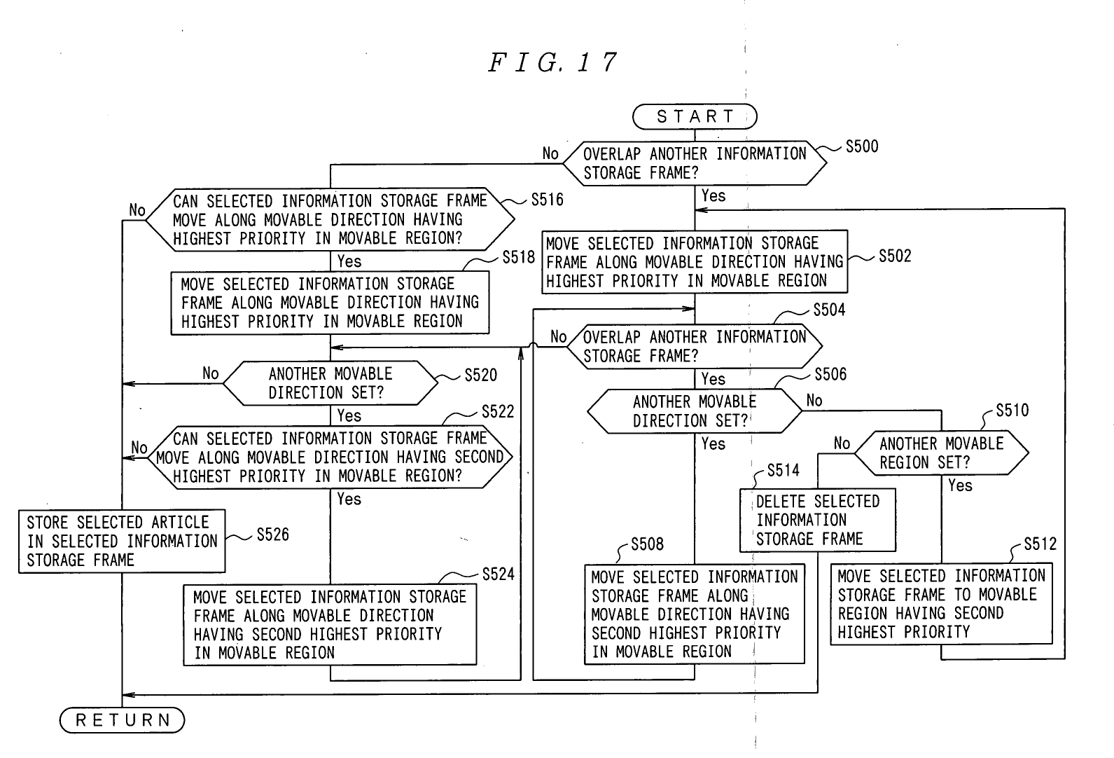

A CPU 30 performs an operation of storing a selected article in the flowchart of FIG. 17 instead of an operation of storing a selected article in the flowchart of FIG. 14. FIG. 17 is a flowchart showing the operation of storing a selected article.

When the operation of storing a selected article is performed in step S318, a transition is firstly made to step S500 as shown in FIG. 17.

In step S500, it is decided whether or not a selected information storage frame overlaps another information storage frame. When it is decided that the selected information storage frame overlaps another information storage frame (Yes), a transition is made to step S502.

In step S502, the selected information storage frame is moved in a movable region along a movable direction having the highest priority and a transition is made to step S504. It is decided whether or not the selected information storage frame overlaps another information storage frame as a result of the movement. When it is decided that the selected information storage frame overlaps another information storage frame (Yes), a transition is made to step S506.

In step S506, it is decided whether or not another movable direction is set in the selected information storage frame. When it is decided that another movable direction is set in the selected information storage frame (Yes), a transition is made to step S508. The selected information storage frame is moved in the movable region along a movable direction having the second highest priority and a transition is made to step S504.

On the other hand, when it is decided in step S506 that another movable direction is not set in the selected information storage frame (No), a transition is made to step S510 to decide whether or not another movable region is set in the selected information storage frame. When it is decided that another movable region is set in the selected information storage frame (Yes), a transition is made to step S512. The selected information storage frame is moved to a movable region having the second highest priority and a transition is made to step S502.

On the other hand, when it is decided in step S510 that another movable region is not set in the selected information storage frame (No), a transition is made to step S514 to delete the selected information storage frame. A series of processing is completed and a return is made to the original processing.

On the other hand, when it is decided in step S500 that the selected information storage frame does not overlap another information storage frame (No), a transition is made to step S516 to decide whether or not the selected information storage frame can be moved in the movable region along the movable direction having the highest priority. When it is decided that the selected information storage frame can be moved in the movable region along the movable direction having the highest priority (Yes), a transition is made to step S518. The selected information storage frame is moved in the movable region along the movable direction having the highest priority and a transition is made to step S520.

In step S520, it is decided whether or not another movable direction is set in the selected information storage frame. When it is decided that another movable direction is set in the selected information storage frame (Yes), a transition is made to step S522.

In step S522, it is decided whether or not the selected information storage frame can be moved in the movable region along the movable direction having the second highest priority. When it is decided that the selected information storage frame can be moved in the movable region along the movable direction having the second highest priority (Yes), a transition is made to step S524. The selected information storage frame is moved in the movable region along the movable direction having the second highest priority and a transition is made to step S520.

On the other hand, when it is decided in step S522 that the selected information storage frame cannot be moved in the movable region along the movable direction having the second highest priority (No), a transition is made to step S526 to store a selected article in the selected information storage frame. A series of processing is completed and a return is made to the original processing.

On the other hand, when it is decided in step S520 that another movable direction is not set in the selected information storage frame (No) and when it is decided in step S516 that the selected information storage frame cannot be moved in the movable region along the movable direction having the highest priority (No), a transition is made to step S526.

On the other hand, in step S504, when it is decided that the selected information storage frame does not overlap another information storage frame (No), a transition is made to step S520.

The operations of the present embodiment will be discussed below.

In a layout process, firstly through steps S300 to S304, a layout region 360 on the front page is set as a processing target, a page template is read from a template registration DB 42 based on a read template application rule, and the read page template is applied to the current layout region 360. Subsequently, through steps S306 to S314, the read page template is applied to the current layout region 360, and the position of a fixed line, the shape and position of fixed character information, and the shape and position of fixed image information are determined in this order.

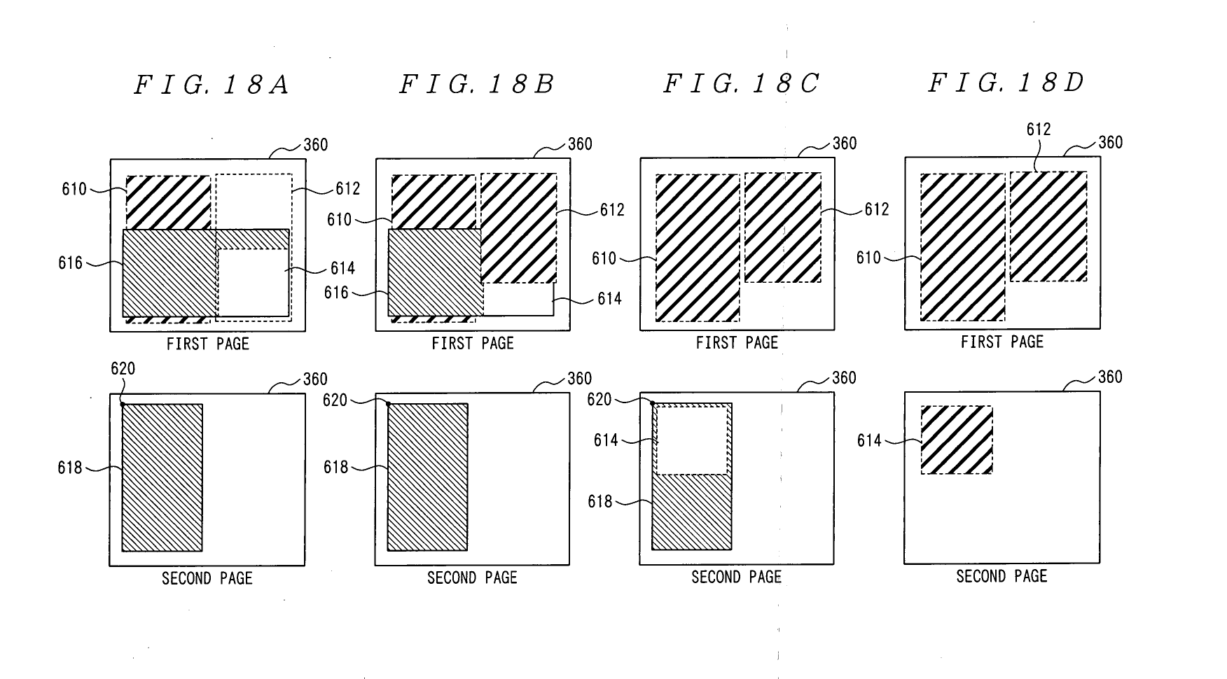

FIGS. 18A to 18D are diagrams for explaining the layout process. In the examples of FIGS. 18A to 18D, when three articles are retrieved from a contents registration DB 44, one of the articles is stored in an information storage frame 610. As shown in FIG. 18A, the information storage frame 610 is arranged on the left of the layout region 360, an information storage frame 612 is arranged on the upper right of the layout region 360, and an information storage frame 614 is arranged on the lower right of the layout region 360. For the information storage frame 614, the lower half region of the layout region 360 on the first page is set as a first priority movable region 616, the left half region of the layout region 360 on the second page is set as a second priority movable region 618, and an upper left position is set as the position of starting arrangement in the movable region 618.

Subsequently, through steps S316 and S318, the information storage frame 612 is selected and a second article is stored in the information storage frame 612. At this moment, since the article stored in the information storage frame 612 has a large amount of information, as shown in FIG. 18B, the lower side of the information storage frame 612 is extended downward and thus the information storage frame 612 becomes larger.

Subsequently, through step S316, the information storage frame 614 is selected. Then, the information storage frame 614 is moved in the movable region 616 having the first priority in order to prevent the information storage frame 614 from overlapping the information storage frames 610 and 612. However, the information storage frame 614 overlaps the information storage frames 610 and 612 in all directions. Thus, through steps S500 to S506, S510, and S512, the information storage frame 614 is moved to the movable region 618 having the second priority as shown in FIG. 18C. At this moment, since the information storage frame 614 is arranged on the upper left of the movable region 618, the information storage frame 614 is arranged on the upper left of the movable region 618.

Then, the information storage frame 614 does not overlap another information storage frame in the movable region 618 or does not need to move along any of the movable directions. Thus, through steps S500, S516, and S526, the layout of the information storage frame 614 is determined by storing a third article in the information storage frame 614 as shown in FIG. 18D.

In this way, according to the present embodiment, a plurality of different movable regions for one information storage frame can be set in the page template. The contents distribution terminal 100 moves the information storage frame in one of the plurality of movable regions. When the information storage frames still overlap each other as a result of the movement, the information storage frame is moved in another region of the plurality of movable regions.

Hence, in the case where the plurality of information storage frames overlap each other, even when the information storage frame cannot be moved in a region intended by the designer, the information storage frame is moved in another region intended by the designer, thereby further improving flexibility for a layout.

Further, in the present embodiment, priorities are set for a plurality of movable regions. The contents distribution terminal 100 moves the information storage frame in a region having the highest priority among the plurality of movable regions. When the plurality of information storage frames still overlap each other as a result of the movement, the information storage frame is moved in a region having the second highest priority among the plurality of movable regions.

Thus, when the plurality of information storage frames overlap each other, regions are sequentially selected according to the priority order intended by the designer and the information storage frame is moved in the selected regions. Hence, the designer's intention can be more readily reflected on a layout and a more proper layout can be obtained regardless of the contents of an article, an amount of information, and a logical structure.

Embodiment 3 of the present invention will be described below in accordance with the accompanying drawings.

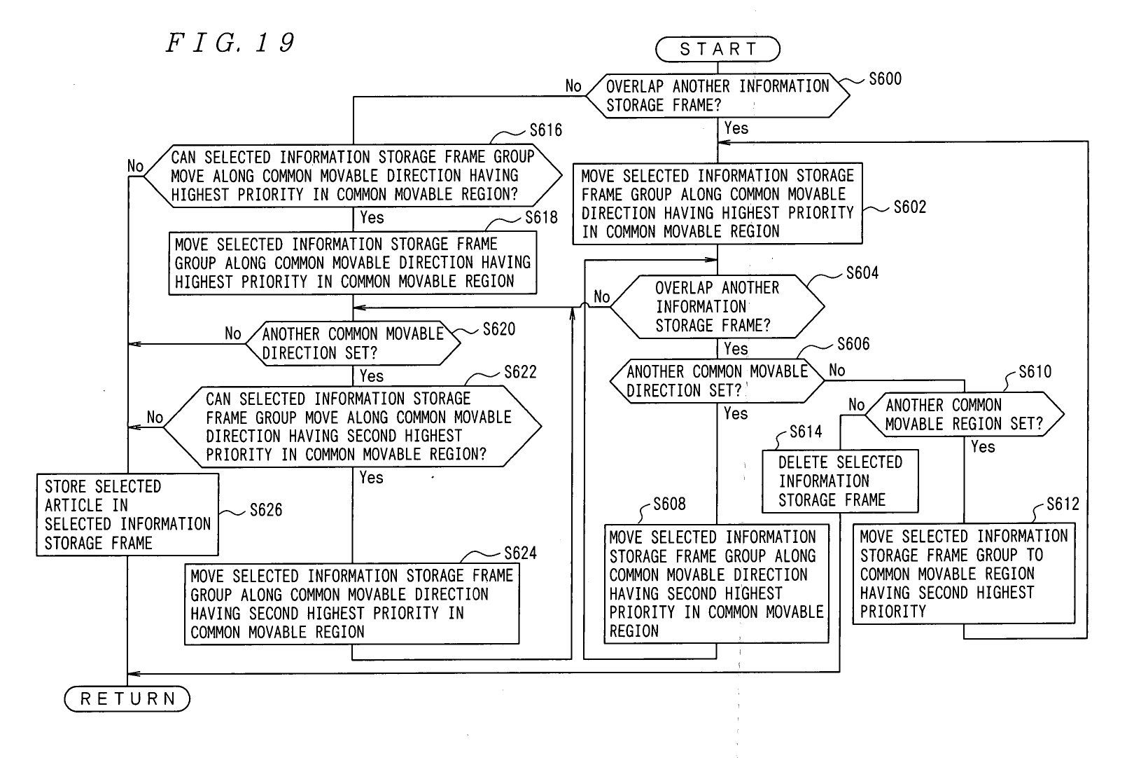

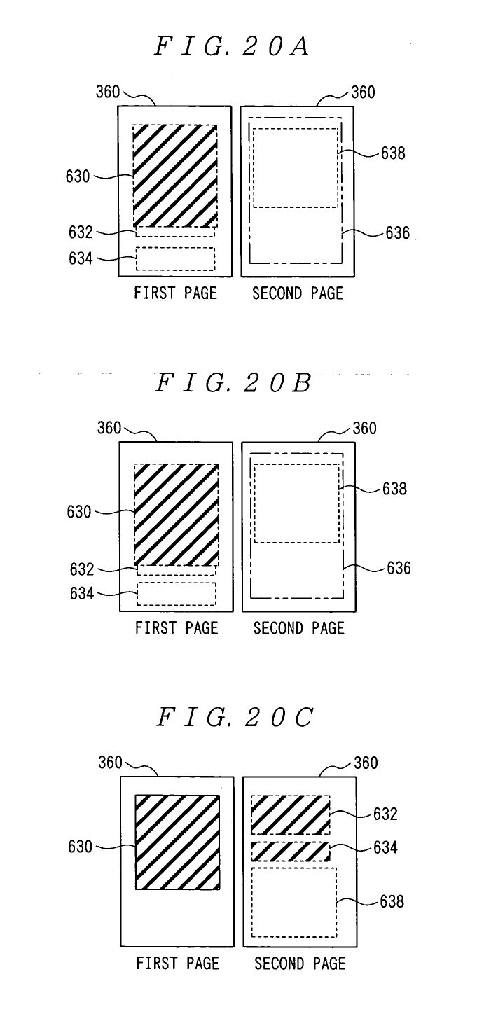

FIGS. 19 and 20 are diagrams showing Embodiment 3 of a layout system, a layout program, and a layout method according to the present invention.

In the present embodiment, the layout system, the layout program, and the layout method of the present invention are applied to the distribution of digital contents such as news from a contents distribution terminal 100 to a user terminal 200. The present embodiment is different from Embodiment 1 in that a common movable direction and movable region are set for a plurality of information storage frames. Hereinafter, only parts different from those of Embodiment 1 will be described. The same parts as Embodiment 1 are indicated by the same reference numerals and the explanation thereof is omitted.

First, the configuration of a page template will be discussed below.

In the page template, a plurality of information storage frames are defined as one group and one or more common movable directions and common movable regions can be set for the group. For example, when two common movable directions are set for the group, a plurality of information storage frames belonging to the group (hereinafter, simply referred to as an information storage frame group) are integrally moved in a common movable region along a common movable direction having a first priority. When overlapping is not made with another information storage frame, the arrangement position is determined. When overlapping is still made with another information storage frame even after the movement, the information storage frame group is integrally moved in the common movable region along a common movable direction having a second priority. Moreover, for example, when two common movable regions are set for the group, the information storage frame group is integrally moved in a common movable region having a first priority along a common movable direction. When overlapping is not made with another information storage frame, the arrangement position is determined. When overlapping is still made with another information storage frame even after the movement, the information storage frame group is integrally moved in a common movable region having a second priority along the common movable direction.

A CPU 30 performs an operation of storing a selected article in the flowchart of FIG. 19 instead of an operation of storing a selected article in the flowchart of FIG. 14. FIG. 19 is a flowchart showing the operation of storing a selected article.

When the operation of storing a selected article is performed in step S318, a transition is firstly made to step S600 as shown in FIG. 19.

In step S600, it is decided whether or not any one of information storage groups of a group where a selected information storage frame belongs (hereinafter, simply referred to as a selected information storage frame group) overlaps another information storage frame. When it is decided that any one of the selected information storage frame groups overlaps another information storage frame (Yes), a transition is made to step S602.

In step S602, the selected information storage frame group is integrally moved in a common movable region along a common movable direction having the highest priority and a transition is made to step S604. It is decided whether or not any one of the selected information storage frame groups overlaps another information storage frame as a result of the movement. When it is decided that any one of the selected information storage frame groups overlaps another information storage frame (Yes), a transition is made to step S606.

In step S606, it is decided whether or not another common movable direction is set in the group where the selected information storage frame belongs. When it is decided that another common movable direction is set in the group where the selected information storage frame belongs (Yes), a transition is made to step S608. The selected information storage frame group is integrally moved in the common movable region along a common movable direction having the second highest priority and a transition is made to step S604.

On the other hand, when it is decided in step S606 that another common movable direction is not set in the group where the selected information storage frame belongs (No), a transition is made to step S610 to decide whether or not another common movable region is set in the group where the selected information storage frame belongs. When it is decided that another common movable region is set in the group where the selected information storage frame belongs (Yes), a transition is made to step S612. The selected information storage frame group is integrally moved to a common movable region having the second highest priority and a transition is made to step S602.

On the other hand, when it is decided in step S610 that another common movable region is not set in the group where the selected information storage frame belongs (No), a transition is made to step S614 to delete the selected information storage frame group. A series of processing is completed and a return is made to the original processing.

On the other hand, when it is decided in step S600 that any one of the selected information storage frame groups does not overlap another information storage frame (No), a transition is made to step S616 to decide whether or not the selected information storage frame group can be moved in the common movable region along a common movable direction having the highest priority. When it is decided that the selected information storage frame group can be moved in the common movable region along the common movable direction having the highest priority (Yes), a transition is made to step S618. The selected information storage frame group is integrally moved in the common movable region along the common movable direction having the highest priority and a transition is made to step S620.

In step S620, it is decided whether or not another common movable direction is set in the group where the selected information storage frame belongs. When it is decided that another common movable direction is set in the group where the selected information storage frame belongs (Yes), a transition is made to step S622.

In step S622, it is decided whether or not the selected information storage frame group can be moved in the common movable region along the common movable direction having the second highest priority. When it is decided that the selected information storage frame group can be moved in the common movable region along the common movable direction having the second highest priority (Yes), a transition is made to step S624. The selected information storage frame group is integrally moved in the common movable region along the common movable direction having the second highest priority and a transition is made to step S620.

On the other hand, when it is decided in step S622 that the selected information storage frame group cannot be moved in the common movable region along the common movable direction having the second highest priority (No), a transition is made to step S626 to store a selected article in the selected information storage frame. A series of processing is completed and a return is made to the original processing.

On the other hand, when it is decided in step S620 that another common movable direction is not set in the group where the selected information storage frame belongs (No) and when it is decided in step S616 that the selected information storage frame group cannot be moved in the common movable region along the common movable direction having the highest priority (No) a transition is made to step S626.

On the other hand, in step S604, when it is decided that any one of the selected information storage frame groups does not overlap another information storage frame (No), a transition is made to step S620.

The operations of the present embodiment will be discussed below.

In a layout process, firstly through steps S300 to S304, a layout region 360 on the front page is set as a processing target, a page template is read from a template registration DB 42 based on a read template application rule, and the read page template is applied to the current layout region 360. Subsequently, through steps S306 to S314, the read page template is applied to the current layout region 360, and the position of a fixed line, the shape and position of fixed character information, and the shape and position of fixed image information are determined in this order.

FIGS. 20A to 20C are diagrams for explaining the layout process. In the examples of FIGS. 20A to 20C, when four articles are retrieved from a contents registration DB 44, a first article is stored in an information storage frame 630. As shown in FIG. 20A, the information storage frame 630 is arranged on the upper half of the layout region 360 on the first page, an information storage frame 632 is arranged on the somewhat lower part at the center of the layout region 360 on the first page, an information storage frame 634 is arranged on the lower part of the layout region 360 on the first page, and an information storage frame 638 is arranged on the upper half of the layout region 360 on the second page. The information storage frames 632 and 634 are defined as a group A. Regarding the group A, the entire surface of the layout region 360 on the second page is set as a common movable region 636, and the downward direction is set as a common movable direction.

Subsequently, through steps S316 and S318, the information storage frame 632 is selected. Since the information storage frame 632 overlaps the information storage frame 630, it is necessary to move the information storage frames 632 and 634 along the common movable direction. Although the downward direction is set as the common movable direction of the group A, the information storage frames 632 and 634 cannot be moved down. Thus, through steps S600 to S606, S610, and S612, the information storage frames 632 and 634 are moved integrally to the common movable region 636 as shown in FIG. 20B.

Then, through step S626, a second article is stored in the information storage frame 632 as shown in FIG. 20C, so that the layout of the information storage frame 632 is determined. Similarly the information storage frame 634 is selected and a third article is stored in the information storage frame 634, so that the layout of the information storage frame 634 is determined.

After that, the information storage frame 638 is selected. Since the information storage frame 638 overlaps the information storage frames 632 and 634, the information storage frame 638 is moved down so as not to overlap the information storage frames 632 and 634. A fourth article is stored in the information storage frame 638, so that the layout of the information storage frame 638 is determined.

In this way, according to the present embodiment, a common movable direction for a group can be set in the page template. When any one of the information storage frame groups overlaps another information storage frame as a result of storing an article in the information storage frame, the contents distribution terminal 100 moves the information storage frame group integrally along the common movable direction so as to keep the information storage frames from overlapping.

Hence, in the case where anyone of the information storage frame groups overlaps another information storage frame, the information storage frame group is integrally moved in a direction intended by the designer. Thus, the designer's intention is more readily reflected on a layout and a more proper layout can be obtained regardless of the contents of an article, an amount of information, and a logical structure.

Further, in the present embodiment, a plurality of different common movable directions for a group can be set in the page template. The contents distribution terminal 100 moves the information storage frame group integrally along one of the plurality of common movable directions. When the information storage frames still overlap each other as a result of the movement, the contents distribution terminal 100 moves the information storage frame group integrally along another direction of the plurality of common movable directions.

Hence, in the case where anyone of the information storage frame groups overlaps another information storage frame, even when the information storage frame group cannot be moved along a direction intended by the designer, the information storage frame group is moved along another direction intended by the designer, thereby further improving flexibility for a layout.

Moreover, in the present embodiment, a common movable region for a group can be set in the page template. When any one of the information storage frame groups overlaps another information storage frame as a result of storing an article in the information storage frame, the contents distribution terminal 100 moves the information storage frame group integrally in the common movable region so as to keep the information storage frames from overlapping.

Thus, when anyone of the information storage frame groups overlaps another information storage frame, the information storage frame group is integrally moved in a region intended by the designer. Hence, the designer's intention is more readily reflected on a layout and a more proper layout can be obtained regardless of the contents of an article, an amount of information, and a logical structure.

Furthermore, in the present embodiment, a plurality of different common movable regions for a group can be set in the page template. The contents distribution terminal 100 moves the information storage frame group integrally in one of the plurality of common movable regions. When the information storage frames still overlap each other as a result of the movement, the contents distribution terminal 100 moves the information storage frame group integrally in another region of the plurality of common movable regions.

Hence, in the case where any one of the information storage frame groups overlaps another information storage frame, even when the information storage frame group cannot be moved in a region intended by the designer, the information storage frame group is moved in another region intended by the designer, thereby further improving flexibility for a layout.

In above-described Embodiments 1 to 3, the information storage frame is moved in the movable region along the movable direction. The configuration is not particularly limited and thus the information storage frame may be moved in the movable region along a desired direction without setting any movable directions. Further, the information storage frame may be moved in the layout region 360 along a movable direction without setting any movable regions.

Although Embodiments 1 to 3 did not particularly describe a specific setting of the movable region, absolute coordinates on each top may be set as a rectangular region or relative coordinates such as “60 mm in the left direction” may be set. Additionally, a polygonal region, a circular region, and other geometric regions as well as a rectangular region may be set.

Moreover, in above-described Embodiments 1 to 3, the priority order of movable directions or movable regions is specified as a listing order in the page template. The configuration is not particularly limited and thus the priority order of the movable directions or movable regions may be explicitly specified by a tag and so on.

Moreover, in above-describe Embodiments 1 to 3, the information storage frame is moved before an article is stored. The configuration is not particularly limited and thus the information storage frame may be moved after an article is stored.

Further, in Embodiment 2, a plurality of movable regions are set for one information storage frame across pages. The configuration is not particularly limited and thus a plurality of movable regions may be set in one page.

Moreover, in Embodiment 3, although the selected. information storage frame group is deleted in step S614, the configuration is not particularly limited. Any one of the selected information storage frame groups may be deleted and the movement of the other selected information storage frame groups may be retried. For example, a selected information storage frame group overlapping other information storage frames may be deleted.

Besides, in above-described Embodiments 1 to 3, character information and image information are used as article information. The article information is not particularly limited and thus, for example, moving image information, voice information, and other kinds of multimedia data may be used as article data.

Further, in above-described Embodiments 1 to 3, a layout is generated while the shape and position of the information storage frame are dynamically determined. The configuration is not particularly limited and thus a layout may be generated by determining the shape and position of each information storage frame after temporarily storing information in all of the information storage frames in the layout region 360.

Moreover, in above-described Embodiments 1 to 3, an output layout of digital contents is determined based on user information. The configuration is not particularly limited and thus an output layout of digital contents maybe determined based on the number of images included in digital contents or an amount of character information included in digital contents.

Hence, whether digital contents include a large number or a small number of images and whether digital contents include a large amount or a small amount of character information, an output layout can be obtained with relatively high visibility.

Further, in above-described Embodiments 1 to 3, the layout processing of step S212 is performed by the contents distribution terminal 100. The configuration is not particularly limited and thus the layout processing may be performed by the user terminal 200. Hence, it is possible to reduce the concentration of a processing load in the content s distribution terminal 100.

Embodiment 4 of the present invention will be described below in accordance with the accompanying drawings.

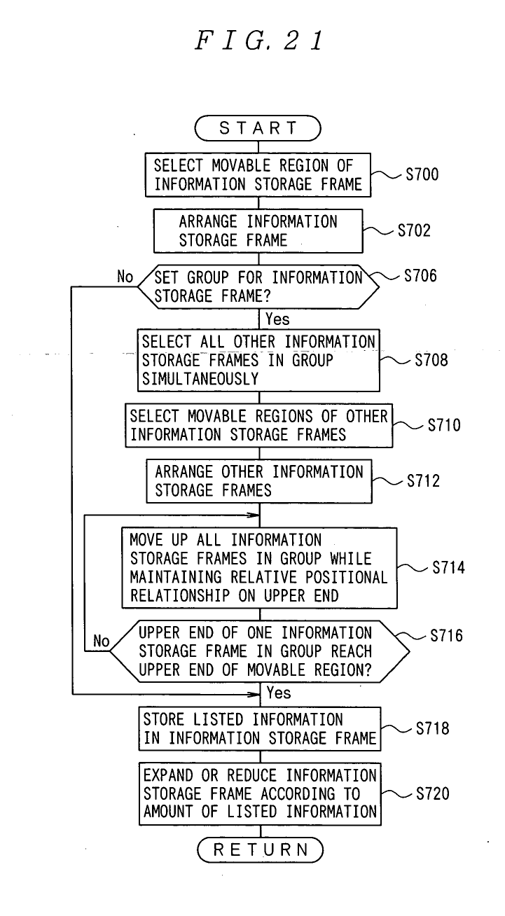

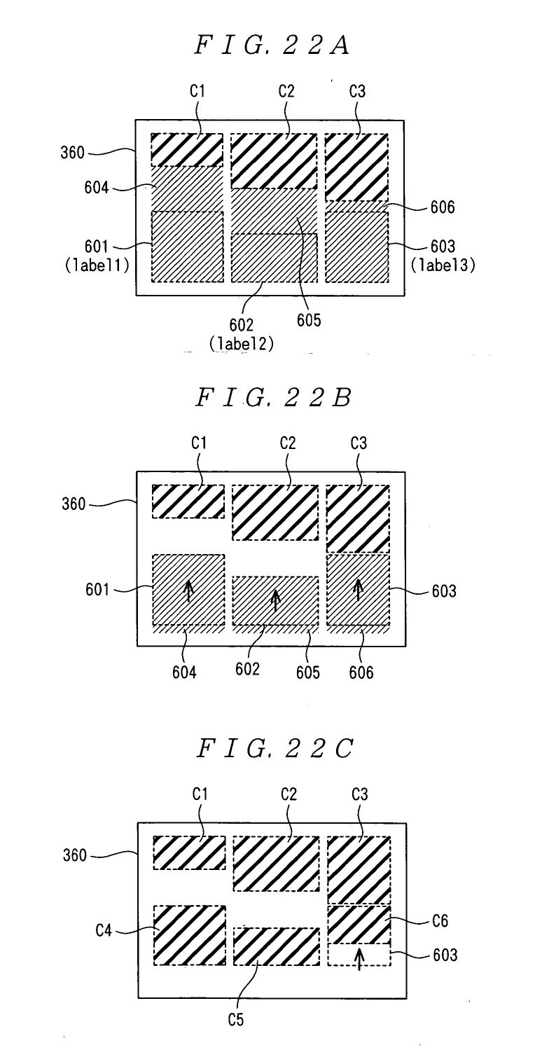

FIGS. 21 and 22 are diagrams showing Embodiment 4 of a layout system, a layout program, and a layout method according to the present invention.

The present embodiment is considerably different from the above-described embodiments in that information storage frames are formed into a group and the information storage frames belonging to the group are moved so as to have a predetermined relative positional relationship. Hereinafter, only parts different from those of the above-described embodiments will be described. The same parts as the above-described embodiments are indicated by the same reference numerals and the explanation thereof is omitted.

In the present embodiment, when a storing flow described in step S318 of FIG. 13 is performed, firstly a transition is made to step S700 as shown in FIG. 21.

In step S700, the movable region of a selected information storage frame is selected and a transition is made to step S702. The information storage frame is arranged in the movable region and a transition is made to step S706. In step S706, it is decided whether or not another information storage frame constituting the group is set in the arranged information storage frame. When it is decided that another information storage frame is set (Yes), a transition is made to step S708.

In step S708, all the other information storage frames in the group are selected at the same time. In step S710, the movable regions of all the selected information storage frames are selected. In step S712, as with the above selected information storage frame, all the other information storage frames are arranged in the movable regions and a transition is made to step S714. In step S714, all the information storage frames in the group that are arranged in the movable regions are moved up while the lower ends of the frames are aligned, and a transition is made to step S716. It is decided whether or not the upper end of any one of the information storage frames in the group reaches the upper end of the movable region as a result of the movement. When it is decided that one of the information storage frames reaches the upper end (Yes) a transition is made to step S718 and later. Besides, when it is decided in step S716 that the upper end of any one of the information storage frames does not reach the upper end of the movable region (No), a return is made to step S714 to move the information storage frames until the information storage frame reaches the upper end.

Then, in step S718, the position is regarded as a finally determined layout position and listed information is stored in each of the information storage frames. In step S720, the lower end of the information storage frame is properly expanded or reduced according to an amount of listed information, so that a series of processing is completed and a return is made to the original processing.

On the other hand, when it is decided in step S706 that any group is not set for the selected information storage frame s (No), a transition is made to step S714 and the subsequent processing is performed.

FIGS. 22A to 22C are diagrams for explaining the layout process of the present embodiment.

Namely, FIGS. 22(a) to 22(c) show that six contents (listed information) are retrieved from a contents registration DB 44. In a state in which three contents (in the present embodiment, individual information listing frames which have already stored listed information and whose sizes and layouts have been determined) C1, C2, and C3 are allocated on the upper part of a layout region 360, another three contents C4, C5, and C6 are laid out under the allocated contents C1, C2, and C3 while maintaining their positional relationships.

In this case, information storage frames 601, 602, and 603 that constitute the contents C4, C5, and C6 to be additionally laid but are formed into rectangles. The information storage frames 601, 602, and 603 belong to “groupA” which is formed under arbitrary conditions as shown in FIG. 6B. Further, the information storage frames 601, 602, and 603 are arranged in three movable regions 604, 605, and 606, respectively, which are formed in the layout region 360, and the information storage frames can be freely moved up.

In the above layout, when the information storage frame 601 called “label1” is firstly selected as a selected information storage frame, as shown in FIG. 22A, the movable region 604 of the information storage frame 601 is selected and the information storage frame 601 is arranged on the lower end of the movable region 604 (steps S700, S702).

Subsequently, as shown in FIG. 6B, the other information storage frames 602 and 603 called “label2” and “label3” are set as the same group in the information storage frame 601. Thus, the information storage frames 602 and 603 are also selected at the same time and are arranged on the lower ends of the movable regions 605 and 606 (steps S706 to S712).

Then, all the information storage frames 601, 602, and 603 in the same group are moved up while the lower ends are aligned (step S716). When one of the information storage frames 601, 602, and 603 has an upper end reaching the upper end of the movable region, even if the other information storage frames can further move up, the other information storage frames are arranged on positions at that time in compliance with the positional relationship with the information storage frame whose movement is restricted.

Namely, as shown in FIG. 22B, among the allocated contents C1, C2, and C3, the lower end of the contents C3 is extended most downward in the present embodiment. When the information storage frames 601, 602, and 603 are moved up while the lower ends are aligned, the upper end of the information storage frame 603 called “label3” first reaches the allocated contents C3. Thus, even if the information storage frames 601 and 602 called “label1” and “label2” can be moved up, since the movement of the information storage frame 603 called “label3” constituting the group with them is restricted, the information storage frames 601 and 602 are not moved up but are arranged on positions at that time.

Then, listed information is stored in the information storage frames 601, 602, and 603 (step S718) and the lower ends thereof are properly expanded or reduced according to an amount of listed information as necessary (step S720), so that the contents C4, C5, and C6 constituting the same group are laid out in the layout region 360. Besides, as shown in FIG. 22C, since an amount of listed information stored in the information storage frame 603 is smaller than the capacity of the frame, the lower end of the frame 603 is reduced upward in the present embodiment.

Namely, by reducing the lower end of the information storage frame having a small amount of listed information, a wide movable region is obtained under the lower end. Thus, if another information storage frame is arranged under the contents, the movable region is made wider to increase the flexibility of the layout.

As described above, in the present embodiment, information storage frames for storing related contents are formed into a group and the information storage frames constituting the group are moved up and are arranged while the lower ends are aligned. Hence, the designer's intention, that is, a layout concept of “related contents are arranged while the lower ends are aligned” is not seriously impaired by a layout regardless of a relationship with allocated contents, the contents of an article, an amount of information, a logical structure, and so on. Hence, it is possible to always obtain a proper layout reflecting the designer's intention.

Besides, in the present embodiment, a layout is generated by moving up the information storage frames while the lower ends are aligned. The same effect can be obtained from a layout generated by aligning the upper ends of information storage frames or moving up the information storage frames while maintaining its relative positional relationship or a given positional relationship. Further, when the movable regions are arranged in upper and lower multiple stages and information storage frames are arranged in the movable regions so as to move in a lateral direction, that is, in the case where the layout region 360 is rotated by 90° in the present embodiment, the same effect can be obtained by laterally moving the information storage frames while the right and left ends of the information storage frames are aligned.

Then, the repetition of such a storing operation is performed until unlisted articles become absent in digital contents having been retrieved in step S206.

Hence, all the articles included in the retrieved digital contents are listed, so that the output layout of the digital contents is determined.

When the output layout is determined, a distribution destination address is read from a user profile table 300 through steps S222 and S224. Generated digital contents for provision are distributed to the read distribution destination address.

Further, in the present embodiment, a contents distribution terminal 100 retrieves digital contents from the contents registration DB 44 based on the user information of a user information registration DB 40. Hence, digital contents are selected by referring to information specific to the user and information specified by the user, thereby generating digital contents for provision relatively in compliance with the requests of the user.

Moreover, in the present embodiment, the contents distribution terminal 100 determines an output layout of digital contents and generates digital contents for provision based on the user information of the user information registration DB 40. Hence, the output layout is determined by referring to information specific to the user and information specified by the user, thereby generating digital contents for provision with an output layout which is relatively compliant with the requests of the user.

Embodiment 5 of the present invention will be described below in accordance with the accompanying drawings.

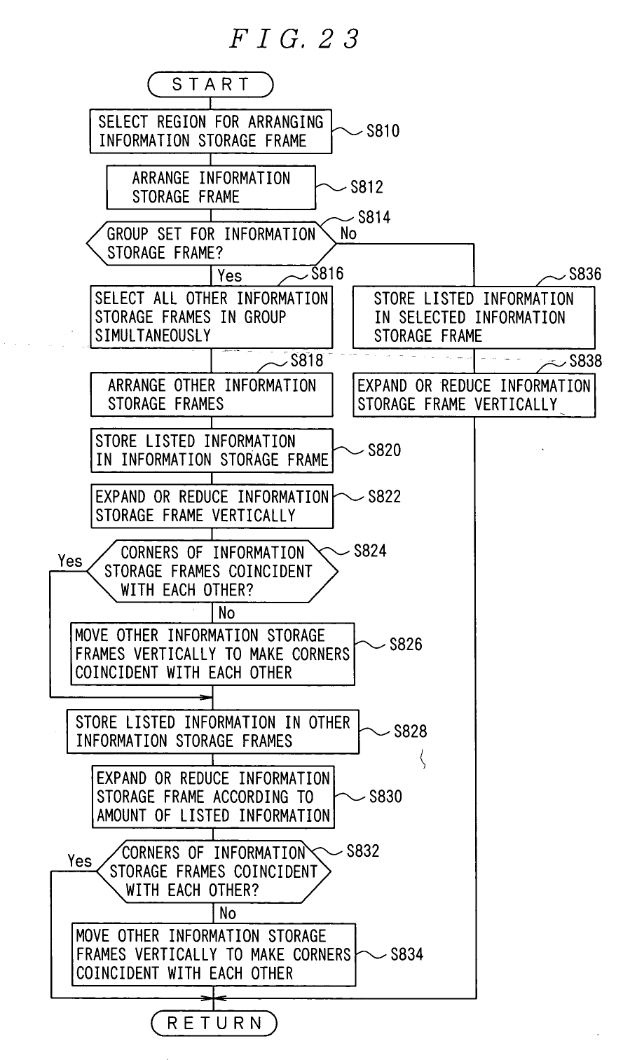

FIGS. 23 to 26 are diagrams showing Embodiment 5 of a layout system, a layout program, and a layout method according to the present invention. A layout is generated by aligning the corners of information storage frames, which are formed into a group as Embodiment 4. As with the above-described embodiments, only parts different from those of the embodiments will be discussed in the present embodiment. The same parts as the above-described embodiments are indicated by the same reference numerals and the explanation thereof is omitted.

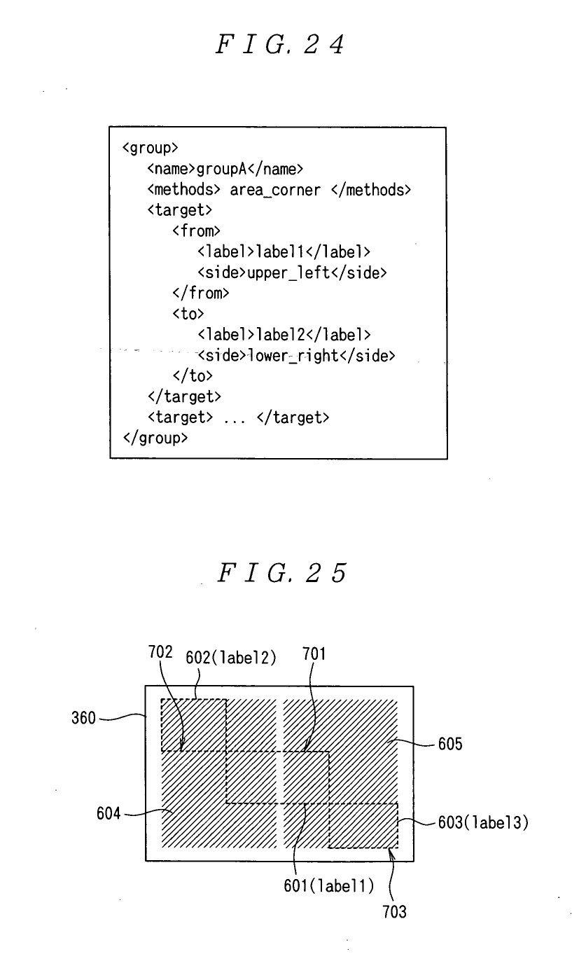

A page template is set as the above-described embodiments and the setting of “groupA” is designated as shown in FIG. 24.

Namely, this designation indicates that “groupA” is moved while maintaining a relative positional relationship between the upper left corner of an information storage frame called “label1” and the lower right corner of an information storage frame called “label2” and a relative positional relationship between the lower right corner of the information storage frame called “label1” and the upper left corner of an information storage frame called “label3”.

Further, as shown in FIG. 25, three rectangular regions 701, 702, and 703 are set on a layout region 360 in the present embodiment. An information storage frame 601 called “label1” is arranged in the region 701 at the center, an information storage frame 602 called “label2” is arranged in the upper left region 702, and an information storage frame 603 called “label3” is arranged in the lower right region 703. A layout is specified in the order of the information storage frames 601, 602, and 603. In FIG. 25, shaded regions 604 and 605 indicate the movable regions of the information storage frames 602 and 603, respectively.

When the information storage frame 601 called “label1” is first selected, as shown in FIG. 25, the region 701 for arranging the information storage frame 601 is selected and the information storage frame 601 is arranged in the region 701 (steps S810 and S812 of FIG. 23).

Subsequently, as shown in FIG. 24, the other information storage frames 602 and 603 called “label2” and “label3” are set as the same group in the information storage frame 601. Thus, the information storage frames 602 and 603 are simultaneously selected and are arranged in the regions 702 and 703, respectively (steps S814 to S816).

In this way, the information storage frame 602 called “label 2” is arranged at the upper left corner of the information storage frame 601 at the center of the layout region and the information storage frame 603 called “label3” is arranged at the lower right corner of the information storage frame 601 (step S818). When the arrangement is completed, predetermined listed information is first stored in the information storage frame 601 (step S820) and the information storage frame 601 is properly expanded or reduced in a vertical direction according to an amount of the listed information (step S822).

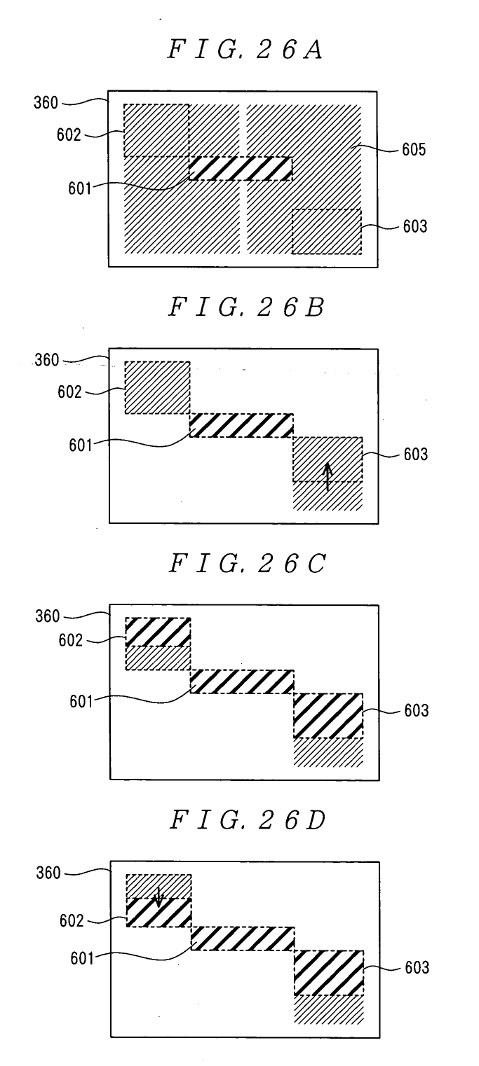

In the present embodiment, since the amount of the listed information is smaller than the capacity of the information storage frame 601, as shown in FIG. 26A, the position of the upper end of the information storage frame 601 is fixed and the lower end thereof is reduced relative to the upper end. As a result of the reduction, a positional relationship is evaluated between the information storage frame 601 at the center and the corners of the other information storage frames (step S824). When the corners of the other information storage frames 602 and 603 are displaced from the information storage frame 601, the other information storage frames 602 and 603 are moved vertically so as to make the corners coincident with the information storage frame 601.

In the present embodiment, as shown in FIG. 26B, since the information storage frame 601 is reduced so as to separate from the information storage frame 603 positioned on the lower right, the information storage frame 603 is moved up on the movable region 605 to make the upper left corner of the information storage frame 603 coincident with the lower right corner of the information storage frame 601, so that the predetermined positional relationship is restored.

Besides, when a storage amount of the information storage frame 601 and an amount of listed information are substantially equal to each other and the information storage frame 601 is not expanded or reduced, the processing of step S826 is omitted in FIG. 23 and the processing of step S828 (storage of listed information) is performed immediately.

Then, when the information storage frames 601, 602, and 603 restore the predetermined relative positional relationship, corresponding listed information is stored in the other information storage frames 602 and 603, and the information storage frames 602 and 603 are expanded or reduced vertically according to the amounts of listed information as with the information storage frame 601 (steps S828 and S830) As a result of the expansion or reduction, a positional relationship is evaluated between the information storage frame 601 at the center and the corners of the other information storage frames 602 and 603 (steps S732). When the corners of the information storage frames 602 and 603 are displaced from the information storage frame 601, the other information storage frames 602 and 603 are similarly moved vertically to make the corners coincident with those of the information storage frame 601.

As shown in FIG. 26C, as a result of reducing the other information storage frames 602 and 603 upward, although the positional relationship of the lower right information storage frame 603 is not changed relative to the information storage frame 601 at the center, the upper left information storage frame 602 is separated upward in the present embodiment. Thus, as shown in FIG. 26D, the information storage frame 602 is moved down to make the lower right corner coincident with the upper left corner of the information storage frame 601, so that the predetermined positional relationship is restored.

On the other hand, as shown in FIGS. 22A to 22C, when any group is not set for the information storage frames selected in step S814, listed information is stored in the information storage frames as it is and expansion or reduction is properly performed to complete the processing (steps S736 and S738).

As described above, in the present embodiment, the information storage frames for storing related contents are formed into a group and the information storage frames constituting the group are moved and arranged so that the corners are aligned. Hence, like the above-described embodiments, the designer's intention is not seriously impaired by a layout regardless of the contents of an article, an amount of information, a logical structure, and so on, thereby achieving a proper layout reflecting the designer's intention of “the contents are arranged while the corners are aligned.”

In the present embodiment, the information storage frames are expanded or reduced vertically and the information storage frames are moved vertically to maintain the original positional relationship. The direction of expanding, reducing, and moving the information storage frames may be a lateral direction. Further, even when expansion, reduction, and movement are performed in a slanting direction, which is a composite direction of a vertical direction and a horizontal direction, the same effect can be obtained as the above-described embodiments.

Embodiment 6 of the present invention will be described below in accordance with the accompanying drawings.

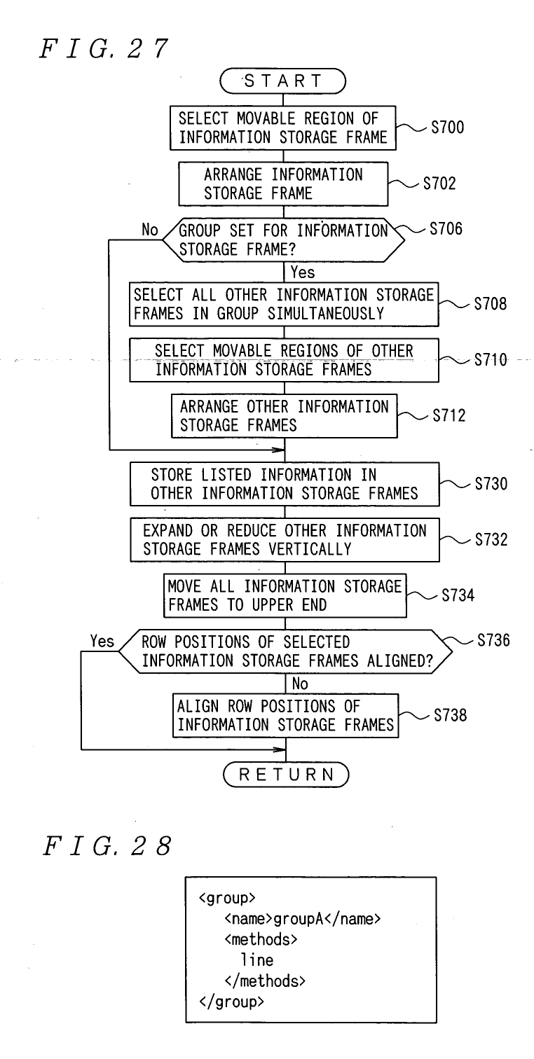

FIGS. 27 to 29 are diagrams showing Embodiment 6 of a layout system, a layout program, and a layout method according to the present invention. A layout is generated by aligning the row positions of information storage frames which are formed into a group as Embodiment 4. As with the above-described embodiments, only parts different from those of the above-described embodiments will be discussed in the present embodiment. The same parts are indicated by the same reference numerals and the explanation thereof is omitted.

A page template is the same as those of the above-described embodiments and the setting of “groupA” is designated as shown in FIG. 28. Namely, in this designation, “groupA” indicates a movement while the row positions of the laid-out information storage frames are aligned.

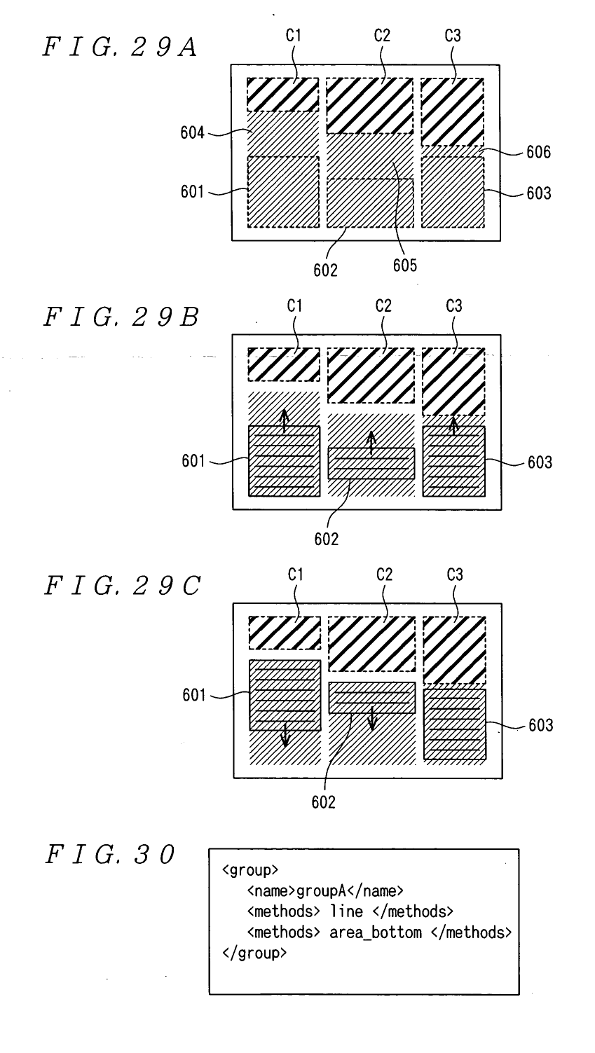

As with the above-described embodiments, in the present embodiment as shown in FIG. 29A, while three contents C1, C2, and C3 are allocated on the upper part of a layout region 360, rectangular information storage frames 601, 602, and 603 constituting “groupA” are arranged on the lower ends of movable regions 604, 605, and 606, respectively, under the allocated contents C1, C2, and C3. Besides, as shown in FIG. 27, the processing so far is the same as steps S700 to S712 of the embodiment shown in FIG. 21.

Subsequently, as shown in FIG. 29B, corresponding listed information is stored in the information storage frames 601, 602, and 603, the information storage frames 601, 602, and 603 are expanded or reduced vertically (steps S730 and S732) according to an amount of listed information, and the information storage frames 601, 602, and 603 are moved to their upper limit positions on the movable regions 604, 605, and 606, respectively (step S434).

In the present embodiment, as shown in FIG. 29B, as a result of storing the listed information, the information storage frame 602 is reduced upward, the information storage frame 603 has the minimum amount of movement, and the information storage frame 601 on the left can be moved to the highest position. Further, the listed information mainly includes character information composed of a character string of horizontal writing, in which at least rows and positions can be recognized by grid lines and so on.

Then, it is decided whether or not the row positions of the information storage frames are all aligned in this state (step S736). When the row positions are aligned, the processing is completed. When the row positions are not aligned, the other information storage frames are moved down relative to one of the information storage frames so as to align all the row positions (step S738).

In the present embodiment, as shown in FIG. 29C, the information storage frames 601 and 602 are moved down relative to the information storage frame 603 having the lowest upper end after the movement, so that the row positions are aligned to that of the information storage frame 603.

In this way, as with the above-described embodiments, the information storage frames for storing related contents are formed into a group, and the information storage frames constituting the group are arranged upward so as to align the row positions. Thus, it is possible to align the row positions of the contents and automatically generate a layout with high visibility.

In the present embodiment, the positions are aligned relative to a row. Alignment may be performed relative to a paragraph. When listed information includes character information mainly composed of a character string of vertical writing and the information storage frames are arranged vertically in multiple stages and can be moved laterally, the present embodiment is applicable also to a layout aligning line positions.

Moreover, as shown in FIG. 30, “groupA” may designate the reference of two relative positions and a movable region may be calculated according to a priority. Namely, in the example of FIG. 30, the bottoms of information storage frames are aligned as much as possible while the row positions are aligned. Further, the designation of “aligning row positions” has a higher priority than the designation of “aligning the bottoms of the information storage frames”.

In the Embodiments 1 to 5 including this embodiment, the information storage frame was moved and then a layout was generated, but not limited thereto, listed information may be arranged in a layout in the information storage frame and then moved. This results in that a layout result for better achieving a designer's purpose can be advantageously provided.

Embodiment 7 of the present invention will be described below in accordance with the accompanying drawings.

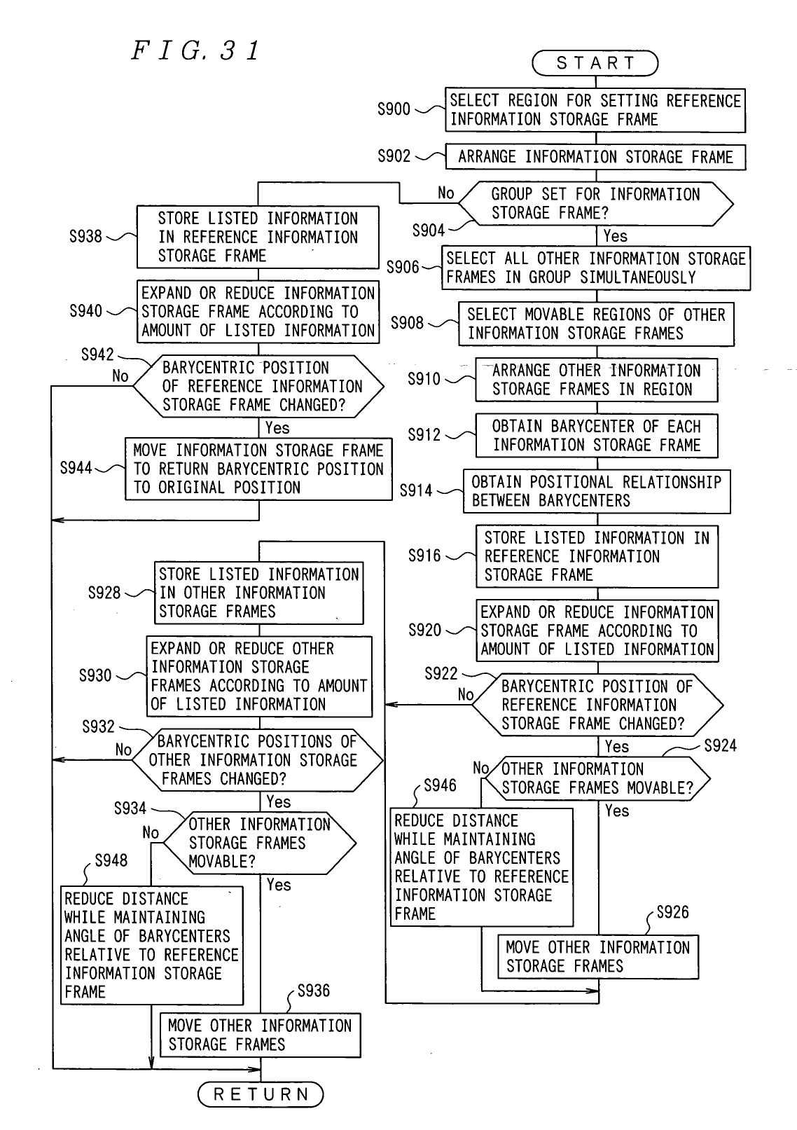

FIGS. 31 to 33 are diagrams showing Embodiment 7 of a layout system, a layout program, and a layout method according to the present invention. A layout is generated while a relative positional relationship is maintained between the barycenters of information storage frames, which are formed into a group in the Embodiment 4. As with the above-described embodiments, only parts different from those of the above-described embodiments will be discussed in the present embodiment. The same parts are indicated by the same reference numerals and the explanation thereof is omitted.

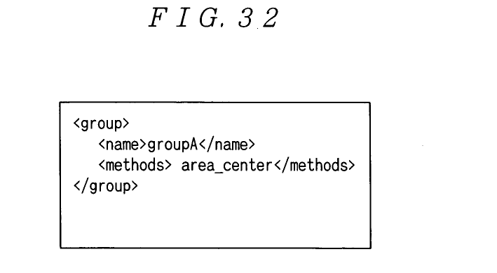

A page template is the same as those of the above-described embodiments and the setting of “groupA” is designated as shown in FIG. 32. Namely, this designation indicates that “groupA” is moved while the relative positional relationship is maintained between the barycenters of the information storage frames.

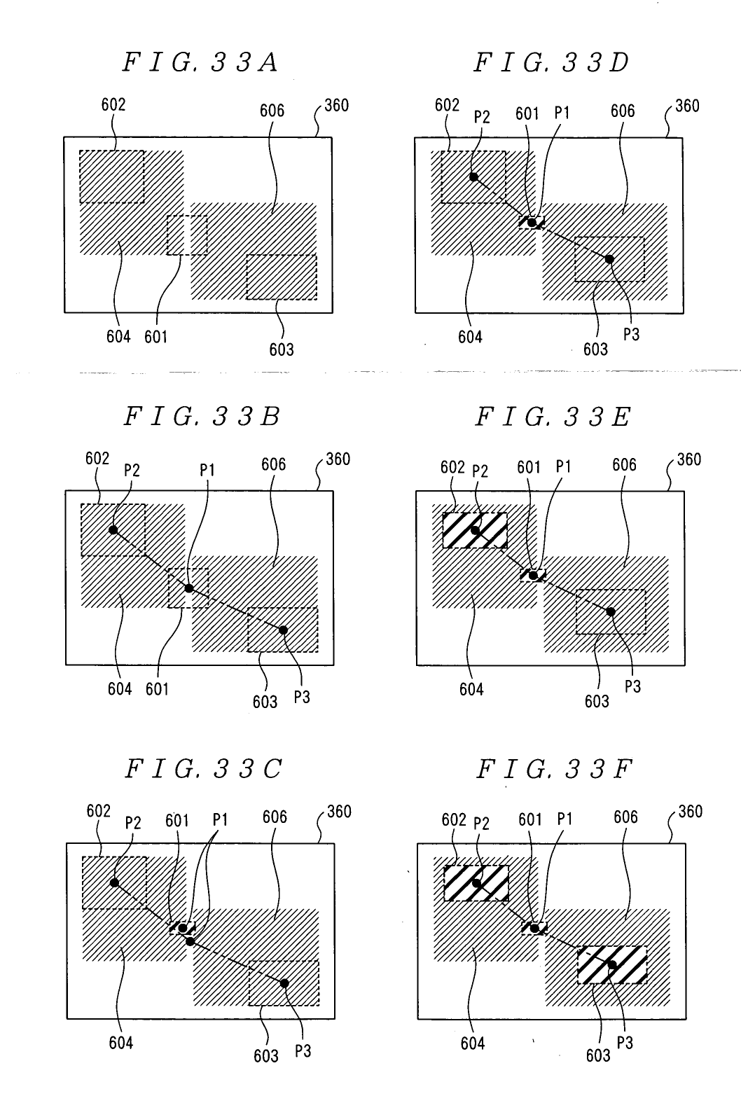

In the present embodiment, as shown in FIG. 33A, three information storage frames 601, 602, and 603 are selected first as one group and the information storage frames 601, 602, and 603 are arranged on a layout region 360 according to a predetermined layout. In the present embodiment, as shown in FIG. 33A, the information storage frame 601 serving as the reference is arranged almost at the center of the layout region 360, and the other information storage frames 602 and 603 are each arranged a predetermined distance away from the lower right corner and the upper left corner of the information storage frame 601 (steps S900 to S910 of FIG. 31).

Then, as shown in FIG. 33B, barycenters P1, P2, and P3 of the information storage frames 601, 602, and 603 are determined. The positional relationship among the barycenters P1, P2, and P3, e.g., distances and angles are calculated and the data is stored (steps S812 and S814).

Subsequently, predetermined listed information is stored in the information storage frame 601 serving as the reference at the center (step S916), the information storage frame 601 is expanded or reduced according to an amount of listed information (step S920), and the position of the barycenter P1 is determined again to decide whether or not the position is displaced from the original position (step S924). When the position is displaced, a displacement is calculated.

In the present embodiment, since the amount of listed information having been stored is considerably smaller than the capacity of the information storage frame 601, as shown in FIG. 33B, the information storage frame 601 is considerably reduced in horizontal and vertical directions relative to the left corner, and the barycenter P1 is accordingly moved somewhat to the upper left from the original position. Hence, when the other information storage frames 602 and 603 can move (step S924), the barycenters P2 and P3 of the other information storage frames 602 and 603 are moved according to a displacement of the barycenter P1 (step S926), so that a desired layout can be maintained without impairing the relative positional relationship among the information storage frames 601, 602, and 603.

In contrast, when the other information storage frames 602 and 603 cannot move while maintaining the relative positional relationship, as shown in FIG. 33D, an angle of the barycenters P1, P2, and P3 is maintained, that is, an angle is maintained between a line connecting the barycenters P1 and P2 and a line connecting the barycenters P2 and P3. In this state, a distance between the barycenters P1 and P2 and a distance between the barycenters P2 and P3 are reduced while a ratio of the distances is maintained (step S946).

Although distances are reduced between the information storage frame 601 and the information storage frames 602 and 603, the angle is maintained and thus the initial relative positional relationship is maintained with a desired layout.

In the present embodiment, as shown in FIG. 33B, the other information storage frames 602 and 603 are arranged on the corners of the movable regions 604 and 606, respectively, and cannot move vertically or horizontally. Thus, as shown in FIGS. 33(c) and 33(d), a desired layout is obtained by reducing the distances between the barycenters P1, P2, and P3 according to a predetermined ratio while maintaining an angle thereof.

Subsequently, when another positional relationship is formed by a displacement of the barycenter P1 of the information storage frame 601 serving as the reference, corresponding listed information is stored in the other information storage frames 602 and 603, and the information storage frames 602 and 603 are expanded or reduced according to an amount of listed information (step S930). Then, when the barycenteric positions of the other information storage frames 602 and 603 are displaced as a result of the expansion or reduction, the other information storage frames 602 and 603 are moved so as to return the barycenteric positions to those just before the displacement (steps S932 to S936).

In the present embodiment, as shown in FIGS. 33(e) and 33(f), as a result of expansion or reduction of the information storage frames 602 and 603 after storing the predetermined listed information in the other information storage frames 602 and 603, when the positions of the barycenters P1 and P2 are displaced again, the expanded or reduced information storage frames 602 and 603 are moved to correct the positions of the barycenters P1 and P2. At this point, when the information storage frames 602 and 603 cannot be moved because of the displacing directions of the barycenters P1 and P2, the distances between the barycenters are reduced again while an angle with the barycenter P1 (step S948) is maintained, so that a predetermined relative relationship can be maintained.

Besides, in step S904, when any group is not set for the selected information storage frame (No), a transition is made to step S938, listed information is stored in the information storage frame, and the information storage frame is expanded or reduced according to an amount of listed information. When the barycenter is changed by the expansion or reduction, the information storage frame is moved so as to return the barycentric position to the original position (steps S940 to S944), so that it is possible to eliminate the inconvenience of a large displacement of the information storage frame from the original position.

In the present embodiment, as with the above-described embodiments, the information storage frames for storing related contents are formed into a group and the information storage frames constituting the group are arranged while maintaining the predetermined relative relationship. Hence, the relative positions of the contents are not seriously displaced, thereby automatically generating a layout reflecting the designer's intention with high visibility.

In the present embodiment, distances of the barycenters P2 and P3 relative to the barycenter P1 are reduced so as to maintain the relative positions of the contents. A distance between the barycenters may be reduced relative to the barycenter P2 or P3.

In the present embodiment, the information storage frames 602 and 603 are moved before listed information is stored in the information storage frames 602 and 603. If the information storage frames 602 and 603 are moved after listed information is stored, expansion or reduction is properly performed, and barycenters are obtained, it is possible to reduce the number of times of moving the information storage frames 602 and 603 with a small processing amount.

The present embodiment described that the three information storage frames constitute the group. It is needless to say that the number of information storage frames is not particularly limited. Further, it is not always necessary to move all the information storage frames constituting the group. A layout may be generated in a state in which one of the information storage frames is fixed and the other information storage frames are moved.

In the present embodiment, the layout processing in step S212 is performed by the contents distribution terminal 100. The configuration is not particularly limited and thus the layout processing may be performed by the user terminal 200. Hence, it is possible to reduce the concentration of a processing load in the contents distribution terminal 100.

Regarding processing shown in the flowcharts of the above-described embodiments, all the embodiments discussed the execution of a control program which is stored in the ROM 32 beforehand. The processing is not particularly limited and thus the following is also applicable: a program is read to the RAM 34 from a storage medium, which stores the program indicating the procedure, and then the program is executed. In this case, the storage medium includes a semiconductor storage medium such as a RAM and a ROM, a magnetic storage medium such as an FD and a HD, an optical reading storage medium such as a CD, CDV, LD, and DVD, and a magnetic storage/optical reading storage medium such as an MO. Regardless of electronic, magnetic, and optical reading methods, all kinds of storage mediums readable by a computer are included.

The embodiments described that the layout system, the layout program, and the layout method of the present invention are applied to the network system constituted of the Internet 199. The configuration is not particularly limited. For example, the present invention may be applied to a so-called intranet for carrying out communications using the same method as the Internet 199. Of course the present invention may be applied to an ordinary network as well as a network for carrying out communications using the same method as the Internet 199.

Further, the embodiments described that the layout system, the layout program, and the layout method of the present invention are used to distribute digital contents such as news from the contents distribution terminal 100 to the user terminal 200 as shown in FIG. 1. The configuration is not particularly limited and thus the layout system, the layout program, and the layout method are applicable to another case within the scope of the present invention.

What is claimed is:

1. A layout system, comprising layout section for laying out listed information, the layout section generating a layout by storing the listed information in a plurality of information storage frames arranged in a predetermined layout region,
wherein a movable direction of the information storage frames on the layout region is set, and
the layout section is set to move one of the information storage frames along the movable direction relative to the other information storage frames.

2. The layout system according to claim 1, wherein when the plurality of information storage frames overlap each other with the listed information stored in the information storage frames, the layout section moves at least one of the plurality of overlapping information storage frames along the movable direction of the information storage frames with the plurality of overlapping information storage frames not overlapping each other.

3. A layout system, comprising layout section for laying out listed information, the layout section generating a layout by storing the listed information in a plurality of information storage frames arranged in a predetermined layout region,
wherein a movable region of the information storage frames on the layout region is set, and
the layout section is set to move one of the information storage frames in the movable region relative to the other information storage frames.

4. The layout system according to claim 3, wherein when the plurality of information storage frames overlap each other with the listed information stored in the information storage frames, the layout section moves at least one of the plurality of overlapping information storage frames in the movable region of the information storage frames with the plurality of overlapping information storage frames not overlapping each other.

5. A layout system, comprising listed information storage section for storing two or more pieces of listed information, listed information selecting section for selecting desired listed information from the listed information registered in the listed information storage section, and layout section for laying out the listed information selected by the listed information selecting section, the layout section generating a layout by storing the listed information in a plurality of information storage frames arranged in a predetermined layout region,
wherein the layout system further comprises template storage section for, regarding the predetermined layout region, storing a template for specifying a matter about the information storage frames arranged in the layout region,
the template can set a movable direction along which the information storage frame moves on the layout region,
the layout section stores the listed information in the plurality of information storage frames according to the template of the template storage section, and when the plurality of information storage frames overlap each other with the listed information stored in the information storage frames, the layout section is set to move at least one of the plurality of overlapping information storage frames along the movable direction of the information storage frames based on a setting on the movable direction in the template.

6. The layout system according to claim 5, wherein the template is a page template for specifying, regarding the layout region constituting a page, at least one of a shape, size, or arrangement of the information storage frame arranged in the layout region.

7. The layout system according to claim 6, wherein the movable direction is at least one of a first direction in a layout plane, a second direction opposed to the first direction, a third direction, and a fourth direction, the third and fourth directions being opposed to each other and perpendicular to the first and second directions.

8. The layout system according to claim 6 or 7, wherein the page template can set the plurality of different movable directions for one information storage frame,
the layout section is set to move the information storage frames along one of the plurality of movable directions, and when the information storage frames still overlap each other, the layout section is set to move the information storage frames along another direction of the plurality of movable directions.

9. The layout system according to claim 8, wherein a priority order is set for the plurality of movable directions, and
the layout section is set to move the information storage frames along a direction having the highest priority of the plurality of movable directions, and the layout section is set to move the information storage frames along a direction having the second highest priority of the plurality of movable directions when the information storage frames still overlap each other.

10. The layout system according to any one of claims 6 to 9, wherein the common movable direction for the plurality of information storage frames can be set in the page template, and
when any one of the plurality of information storage frames, which has the set common movable direction, overlaps another information storage frame with the listed information stored in the information storage frames, the layout section is set to move the plurality of information storage frames, which have the set common movable direction, along the common movable direction.

11. The layout system according to claim 10, wherein the plurality of different common movable directions for the plurality of information storage frames can be set in the page template,
the layout section is set to move the plurality of information storage frames along one of the plurality of common movable directions, and when the information storage frames still overlap each other, the layout section is set to move the plurality of information storage frames along another direction of the plurality of common movable directions with the information storage frames not overlapping each other.

12. A layout system, comprising listed information storage section for storing two or more pieces of listed information, listed information selecting section for selecting the desired listed information from the listed information registered in the listed information storage section, and layout section for laying out the listed information selected by the listed information selecting section, the layout section generating a layout by storing the listed information in a plurality of information storage frames arranged in a predetermined layout region,
wherein the layout system comprises template storage section for, regarding the predetermined layout region, storing a template for specifying a matter about the information storage frames arranged in the layout region,
the template can set a movable region in which the information storage frame moves on the layout region,
the layout section stores the listed information in the plurality of information storage frames according to the template of the template storage section, and when the plurality of information storage frames overlap each other with the listed information stored in the information storage frames, the layout section is set to move at least one of the plurality of overlapping information storage frames in the movable region of the information storage frames based on a setting on the movable region in the template.

13. The layout system according to claim 12, wherein the template is a page template for specifying, regarding the layout region constituting a page, at least one of a shape, size, or position of the information storage frame arranged in the layout region.

14. The layout system according to claim 13, wherein the shape of the movable region is at least one of a rectangular shape, a circular shape, and other geometric shapes.

15. The layout system according to claim 13 or 14, wherein the plurality of different movable regions for each of the information storage frames can be set in the page template,
the layout section is set to move the information storage frame in one of the plurality of movable regions, and when the information storage frames still overlap each other, the layout section is set to move the information storage frame in another region of the plurality of movable regions.

16. The layout system according to claim 15, wherein a priority order is set for the plurality of movable regions,
the layout section is set to move the information storage frame in a region having a highest priority among the plurality of movable regions,
and when the plurality of information storage frames still overlap each other, the layout section is set to move the information storage frame in a region having a second highest priority among the plurality of movable regions.

17. The layout system according to claim 15 or 16, wherein the plurality of movable regions can be set across pages.

18. The layout system according to any one of claims 13 to 17, wherein the common movable region for the plurality of information storage frames can be set in the page template, and
when one of the plurality of information storage frames, which have the set common movable region, overlaps another information storage frame with the listed information stored in the information storage frames, the layout section is set to move the plurality of information storage frames, which have the set common movable region, in the common movable region.

19. The layout system according to claim 18, wherein the plurality of different common movable regions for the plurality of information storage frames can be set in the page template,
the layout section is set to move the plurality of information storage frames in one of the plurality of common movable regions, and when the information storage frames still overlap each other, the layout section is set to move the plurality of information storage frames in another region of the plurality of common movable regions with the information storage frames not overlapping each other.

20. A layout system, comprising listed information storage section for storing two or more pieces of listed information, listed information selecting section for selecting the listed information from the listed information storage section, and layout section for laying out the listed information selected by the listed information selecting section, the layout section generating a layout by storing the listed information in a plurality of information storage frames arranged in a predetermined layout region,
wherein the layout system comprises template storage section for, regarding the predetermined layout region, storing a template for specifying a matter about the information storage frames arranged in the layout region,
the template can set a movable direction along which the information storage frame moves on the layout region, and a movable region,
the layout section stores the listed information in the plurality of information storage frames according to the template of the template storage section, and when the plurality of information storage frames overlap each other, the layout section is set to move the overlapping information storage frames in the movable region along the movable direction based on a setting on the movable direction and the movable region in the template to a position where the information storage frames do not overlap each other.

21. The layout system according to any one of claims 5 to 20, further comprising user information storage section for storing user information about a user,
wherein the listed information selecting section selects the listed information from the listed information storage section based on the user information of the user information storage section.

22. The layout system according to any one of claims 5 to 20, further comprising user information storage section for storing user information about a user,
wherein the layout section lays out listed information, which is selected by the listed information selecting section, based on the user information of the user information storage section.

23. A layout program for causing a computer to perform processing realized as the layout section of a layout system,
wherein when the plurality of information storage frames overlap each other with the listed information stored in the information storage frames, the layout section moves at least one of the plurality of overlapping information storage frames along a movable direction of the information storage frames with the plurality of overlapping information storage frames not overlapping each other.

24. A layout program for causing a computer to perform processing realized as the layout section of a layout system,
wherein when the plurality of information storage frames overlap each other with the listed information stored in the information storage frames, the layout section moves at least one of the plurality of overlapping information storage frames in a movable region of the information storage frames with the plurality of overlapping information storage frames not overlapping each other.

25. A layout method, comprising a layout step of laying out listed information, the layout step generating a layout by storing the listed information in a plurality of information storage frames arranged in a predetermine layout region,
wherein the layout method includes a movable direction setting step of setting a movable direction of the information storage frames on the layout region, and
when the plurality of information storage frames overlap each other with the listed information stored in the information storage frames, the layout step moves at least one of the plurality of overlapping information storage frames along the movable direction of the information storage frames.

26. A layout method, comprising a layout step of laying out listed information, the layout step generating a layout by storing the listed information in a plurality of information storage frames arranged in a predetermine layout region,
wherein the layout method includes a movable direction setting step of setting a movable region of the information storage frames on the layout region, and
when the plurality of information storage frames overlap each other with the listed information stored in the information storage frames, the layout step moves at least one of the plurality of overlapping information storage frames in the movable region of the information storage frames.

27. A layout system, comprising layout section for generating a layout by arranging a plurality of information storage frames movably on a layout region and storing listed information in the information storage frames,
wherein the layout section forms the information storage frames into a group and is set to move at least one of the information storage frames belonging to the same group so as to have a predetermined relative positional relationship with each other.

28. A layout system, comprising layout section for generating a layout by arranging a plurality of information storage frames movably on a layout region and storing listed information in the information storage frames,
wherein the layout section forms the information storage frames into a group, arranges the information storage frames, which belong to the same group, laterally on the layout region, and is set to move some or all of the information storage frames vertically so as to align upper ends or lower ends, so that a layout is generated.

29. A layout system, comprising layout section for generating a layout by arranging a plurality of information storage frames movably on a layout region and storing listed information in the information storage frames,
wherein the layout section forms the information storage frames into a group, arranges the information storage frames, which belong to the same group, vertically on the layout region, and is set to move some or all of the information storage frames laterally so as to align right ends or left ends, so that a layout is generated.

30. A layout system, comprising layout section for generating a layout by arranging a plurality of information storage frames movably on a layout region and storing listed information, which is composed of a character string of horizontal writing, in the information storage frames,
wherein the layout section forms the information storage frames into a group, arranges the information storage frames, which belong to the same group, laterally on the layout region, and is set to move some or all of the information storage frames vertically so as to align row positions, so that a layout is generated.

31. A layout system, comprising layout section for generating a layout by arranging a plurality of information storage frames movably on a layout region and storing listed information, which is composed of a character string of vertical writing, in the information storage frames,
wherein the layout section forms the information storage frames into a group, arranges the information storage frames, which belong to the same group, vertically on the layout region, and is set to move some or all of the information storage frames laterally so as to align line positions, so that a layout is generated.

32. A layout system, comprising layout section for generating a layout by arranging a plurality of rectangular information storage frames movably on a layout region and storing listed information in the information storage frames,
wherein the layout section forms the information storage frames into a group, arranges the information storage frames, which belong to the same group, diagonally on the layout region, and moves some or all of the information storage frames so as to connect corners, so that a layout is generated.

33. The layout system according to any one of claims 27 to 32, wherein the layout system is set so that the information storage frames are expandable or reducible according to an amount of the listed information, and when the positional relationship is changed by expansion or reduction, some or all of the information storage frames are further moved so as to have an original relative positional relationship, so that a layout is generated.

34. A layout system, comprising layout section for generating a layout by arranging a plurality of information storage frames movably on a layout region and storing listed information in the information storage frames,
wherein the layout section forms the information storage frames into a group, arranges the information storage frames, which belong to the same group, so as to have a relative positional relationship on the layout region, can expand or reduce the information storage frames according to an amount of the listed information, determines a relative positional relationship between barycenters of the information storage frames before storing the listed information, and when a barycenter of the information storage frame serving as a reference is displaced by expansion or reduction of the information storage frame, the layout section is set to displace barycenters of the other information storage frames according to a displacement amount to maintain the predetermined relative positional relationship, so that a layout is generated.

35. The layout system according to claim 34, wherein when the barycenter of the information storage frame serving as the reference is displaced and the other information storage frames accordingly move out of the layout region, the layout section is set to reduce a distance between the barycenters while maintaining a ratio of distances in the relative positional relationships of the information storage frames, so that a layout is generated.

36. The layout system according to any one of claims 27 to 35, wherein when the information storage frames are moved, the layout section is set to move the information storage frames to a position where none of the information storage frames overlaps allocated information storage frames of another group, so that a layout is generated.

37. The layout system according to any one of claims 27 to 36, wherein the layout section is set to lay out the information storage frames based on a template for defining a layout of the listed information beforehand.

38. A layout program for realizing a function of layout section by means of a computer, the layout section generating a layout by arranging a plurality of information storage frames movably on a layout region and storing listed information in the information storage frames,
wherein the layout section forms the information storage frames into a group and is set to move the information storage frames, which belong to the same group, so as to have a relative positional relationship with each other.

39. A layout program for realizing a function of layout section by means of a computer, the layout section generating a layout by arranging a plurality of information storage frames movably on a layout region and storing listed information in the information storage frames,
wherein the layout section forms the information storage frames into a group, moves the information storage frames, which belong to the same group, so as to have a predetermined relative positional relationship, and stores the listed information in the information storage frames, and when the information storage frame is expanded or reduced according to an amount of the stored listed information and changes the positional relationship, the layout section is set to move the information storage frames so as to have the predetermined relative positional relationship again, so that the listed information is laid out.

40. A layout method, wherein a plurality of information storage frames, which are formed into a group, are arranged movably on a layout region, the information storage frames constituting the group are moved so as to have a predetermined relative positional relationship, and listed information is stored in the information storage frames, so that listed information is laid out.

41. A layout method, wherein a plurality of information storage frames, which are formed into a group, are arranged movably on a layout region, the information storage frames constituting the group are moved so as to have a predetermined relative positional relationship, listed information is stored in the information storage frames, the information storage frames are expanded or reduced according to an amount of the listed information, and the information storage frames are moved so as to restore a relative positional relationship of the information storage frames, which have been changed by expansion or reduction, to the predetermined relative positional relationship, so that listed information is laid out.
